(19) United States
(12) Patent Application Publication
(10) Pub. No.: US 2013/0260333 A1
(43) Pub. Date: Oct. 3, 2013

(54) SEAMLESS AIR/WATER DENTAL SYRINGE TIP ADAPTER SYSTEMS AND CONVERSION METHODS

(71) Applicant: Donovan Berkely, Irvine, CA (US)

(72) Inventor: Donovan Berkely, Irvine, CA (US)

(21) Appl. No.: 13/907,296

(22) Filed: May 31, 2013

Related U.S. Application Data
(63) Continuation-in-part of application No. 13/841,280, filed on Mar. 15, 2013.
(60) Provisional application No. 61/619,578, filed on Apr. 3, 2012.

(51) Int. Cl. A61C 17/02

(52) U.S. Cl. CPC A61C 17/0217
USPC 433/80

(57) ABSTRACT

Conversion assemblies enable a disposable tip to connect to an existing air/water dental syringe configured to receive a non-disposable tip. A conversion kit enabling an air/water syringe body to receive a disposable tip includes a retainer body having a distal opening into which the proximal end of the elongated disposable tip is inserted, and one or more internal components with cut-outs, grooves or channels to direct air and water from the syringe body to the air-carrying channels and water-carrying tube of the disposable tip. All of the components internal to the retainer are installed through the proximal opening in the retainer, enabling the proximal end of the retainer to be adjacent to the syringe body, such that there are no seams in the outer surface of the retainer from the syringe body to the distal end of the retainer that might collect pathogens or dirt.

### REFERENCE TO RELATED APPLICATION

This application is a continuation-in-part of U.S. patent application Ser. No. 13/841,280, filed Mar. 15, 2013, which claims priority from U.S. Provisional Patent Application Ser. No. 61/619,578, filed Apr. 3, 2012, the entire content of both applications being incorporated herein by reference.

### FIELD OF THE INVENTION

This invention relates generally to air/water syringes and, in particular, to adapter units that enable replaceable, disposable tips to be used with various handle assemblies including European style syringes.

### BACKGROUND OF THE INVENTION

Dental syringes are hand-held instruments which deliver water and air under pressure into a patient's mouth for washing and drying purposes. Such instruments are widely used by dentists, orthodontists, oral surgeons, dental hygienists and dental assistants. A typical dental includes a head unit which is coupled to hoses that supply water at about 40 PSI and air at about 80 PSI. An elongated tip coupled to the head unit is inserted into a patient's mouth, and buttons on the head unit are operated to discharge water or air through the distal end of the tip.

Cross contamination is one of the principal problems encountered with dental syringes. Bacteria and viruses can be communicated from patient to patient unless the syringe tip is adequately sanitized. The safest and most desirable approach is to replace the syringe tip from the head after each patient treatment. In addition, it is desirable to be able to replace worn tips or change to tips of different configurations quickly and easily.

Several decades ago, dental syringe tips were not readily removable from the syringe head units. Removal often necessitated the unscrewing of a coupling from the head and the sliding of the coupling off of the tip. Around this time, the tip once removed and the associated coupling were autoclaved. A number of small elastomeric O-rings had to be removed before autoclaving because they could not withstand the heat and pressure of the autoclaving process. The entire process was a time consuming, often frustrating experience.

Around 1980, dental syringe quick-disconnect tips were invented. U.S. Pat. No. 4,248,589, the entire content of which is incorporated herein by reference, discloses a dental syringe that includes a head 10, a coupling 12, and a removable, replaceable tip 14 (FIG. 1). The head 10 has internal water and air passages 16 and 18 in communication with an internally threaded cylindrical cavity 22 in the top frontal surface of the head (FIG. 2). The head and tip include a corresponding number of fluid passages. The coupling 12 includes a cylindrical base and a lock nut which screws over the base. The base and the lock nut define an axially extending bore which communicates with the passages through the head and removably receives the rearward portion of the tip 14. An elastomeric O-ring is positioned between the base and the lock nut and surrounds the bore. When the rearward portion of the tip is fully inserted in the bore the O-ring seats in a groove surrounding the rearward portion of the tip. When the lock nut is fully screwed over the base, deformation of the O-ring is substantially prevented and the tip cannot be withdrawn or ejected from the coupling.

The tip 14 comprises inner and outer elongate, coaxial, spaced apart pipes 36 and 38 which define water and air passages 40 and 42, respectively. The forward portions of the pipes are angled with respect to the rearward portions. The forward end 44 of the inner pipe 36 is open and the forward end 46 of the outer pipe 38 is bent inwardly and is sealed to the inner pipe 36. The forward end 46 has a plurality of annularly spaced nozzle apertures such as 48.

The rearward portion 50 of the outer pipe 38 terminates short of the rearward portion 52 of the inner pipe 36 and is bent inwardly and sealed to the rearward portion 52. The rearward end 53 of the inner pipe 36 is open and coaxial with the water passage 16 and abuts the bottom of the cavity 22 when inserted in the coupling 12. The periphery of the rearward portion 50 is formed with a pair of axially spaced, rearward and forward annular grooves 54 and 56. A pair of diametrically positioned inlet apertures 58 and 60 extend through the wall of the outer pipe 38 in the groove 54, as shown in FIG. 3.

Ducts 82 and 84 in the base 62 extend from the bore 72 in the base to a chamber 80. When the rearward portion of the tip is fully inserted in the bore 72, air can flow from the air passage 18 into the chamber 80, through the ducts 82 and 84, into the bore 72, through the apertures 58 and 60, into the air passage 42 and through the tip.

Push buttons 24 and 26 on the top rear surface of the head are coupled to normally closed valves and are selectively hand-operated to discharge water, air, or both through the distal end 28 of the tip 14. A handle 30 can be threaded with the shank 20 to connect water and air supply hoses 32 and 34 to the water and air passages 16 and 18, respectively. When the push buttons 24 and 26 are simultaneously depressed water spray mist is produced.

Since the development of the quick-release syringe tip system just described several improvements have taken place. Central to such improvements is the development of the disposable tip which is retrofittable to the older metal units which must be autoclaved to reuse. Disposable air/water syringe tips resemble bent, plastic straws with multiple cannulations to receive and deliver air and water from existing hand-held units. One leading manufacturer is Crystal Tip of Irvine, Calif.

As with the earlier, autoclavable metal syringe tips, the proximal end of the Crystal Tip includes a central, protruding tube to receive water which, like its predecessors, seals against an O-ring in the syringe body. However, as shown in FIG. 4, the tip does not have proximal side ducts through which the air flows; rather the proximal end surrounding the water tube does not ‘bottom out’ within the syringe body, allowing air to enter the cannulations surrounding the central water tube. Crystal Tips are designed to be used directly on common U.S. and Canadian syringes. In particular, Crystal Tips fit syringes from Adec (Newberg, Oreg.), DCI International (Newberg, Oreg.) and Unic/Heka (Ishøj, Denmark) without the need for any so-called adapter units.

Currently in Europe, however, most syringes use autoclavable tips. As a result, there has been little attempt to upgrade to new standards that have been in place for years. As such, disposable tips, including Crystal Tips, cannot be used directly on any European syringe. Syringes with autoclavable tips use a variety of routing patterns to deliver air and water to the tip. However, all U.S. disposable tips receive their air flow through the base of the tip that is inserted into the syringe. Autoclavable tips route air flow through a side port (hole) directly below an O-ring grove on the metal tip. As such, without some type of conversion, disposable tips are incompatible with European-style syringes that use autoclavable tips.

Given that there are numerous proprietary designs outside North America, it would be advantageous to provide these syringes with appropriate adapter kits enabling them to utilize standard, disposable quick-release air/water tips.

U.S. patent application Ser. No. 13/841,280, filed Mar. 15, 2013, discloses numerous conversion kits enabling disposable tips to be used on multiple different syringe bodies, including European designs that use autoclavable tips. However, the embodiments described in this previous application use two subassemblies—a cap subassembly that receives the disposable tip, and an adapter subassembly that couples the cap to the syringe body after the non-disposable or autoclavable tip has been removed.

The cap subassembly 402, shown in FIG. 4, includes an outer body 403 with a distal end to receive the tip 400 and a proximal end configured to receive a ferrule 420 shown in FIG. 5. The ferrule includes a cup-shaped receptacle that receives the proximal end of the disposable tip once inserted into the cap body 403. The disposable tip is shown in FIGS. 4 and 6 at 400. View 401 is an end view showing the central water-carrying tube 404 surrounded by air-carrying channels 406. In the tip shown, a Crystal Tip from Westside Resources of Irvine, Calif., the water tube protrudes from the proximal end of the tip at 408, facilitating an additional O-ring seal at 410 for enhanced air/water separation. The proximal end of tip 400 includes a tapered region to ensure that the tip end does not “bottom out” against the bottom of the ferrule cup. This allows air to flow through side grooves 502 and into the air-carrying channels 406 of the tip. Again, however, as long as access to the air-carrying channels is provided, such a tapered region is not necessarily required.

While the conversion kits disclosed in the '280 Application effectively allow disposable tips to be used in conjunction with multiple different syringe systems, the use of two subassemblies including a separate cap and adapter results in a seam around the completed assembly. If this seam could be eliminated, the result would be a more streamlined solution with the potential for easier cleaning and/or sterilization.

### SUMMARY OF THE INVENTION

This invention resides in conversion assemblies enabling a disposable tip to connect to an existing dental syringe configured to receive a different type of tip such as an autoclavable tip. The tip has proximal and distal ends with a central, water-carrying tube surrounded by air-carrying channels. The tip, typically constructed from extruded or molded plastic, may be straight or bent, and may have flat flush ends or a water tube that extends outwardly from the proximal end.

A conversion kit enabling an air/water syringe body to receive a disposable tip includes a retainer body having a distal opening into which the proximal end of the elongated disposable tip is inserted, and one or more internal components with cut-outs, grooves or channels to direct air and water from the syringe body to the air-carrying channels and water-carrying tube of the disposable tip.

In accordance with the invention, all of the components internal to the retainer are installed through the proximal opening in the retainer, enabling the proximal end of the retainer to be adjacent to the syringe body, such that there are no seams in the outer surface of the retainer from the syringe body to the distal end of the retainer that might collect pathogens or dirt. The completed assembly is preferably autoclavable in the absence of the disposable tip.

The configuration of the retainer and internal components are varied in alternative embodiments to accommodate a wide variety of syringe styles. As examples, the completed conversion kit may include a proximal receptacle to receive a stem on the syringe body; a proximal stem insertable into the syringe body; one or more proximal air- or water-carrying tubes insertable into the syringe body; or a threaded connection to the syringe body.

### BRIEF DESCRIPTION OF THE DRAWINGS

FIG. 1 is an exploded isometric view of a prior art dental syringe showing its quick-release tip withdrawn;

FIG. 2 is an enlarged side elevational view of the dental syringe of FIG. 1 with portions broken away;

FIG. 3 is a sectional view taken along line 3-3 of FIG. 2;

FIG. 4 is a drawing in partial cross section showing an existing cap subassembly and disposable tip;

FIG. 5 is a side view of a ferrule used in the cap subassembly of FIG. 4, showing side grooves configured for the passage of air;

FIG. 6 is an exploded view illustrating how the invention replaces an autoclavable tip on a generic, European-style with a conversion kit and disposable tip;

FIG. 7A is a side view of a threaded ferrule constructed in accordance with the present invention, also including side grooves configured for the passage of air;

FIG. 7B illustrates a two-piece ferrule construction applicable to disposable Crystal Tips having extended proximal water-carrying tubes;

FIG. 7C illustrates an alternative two-piece ferrule construction applicable to disposable Crystal Tips having extended proximal water-carrying tubes;

FIG. 7D illustrates a three-piece ferrule construction applicable to disposable Crystal Tips having extended proximal water-carrying tubes;

FIG. 7E illustrates an alternative three-piece ferrule construction applicable to disposable Crystal Tips having extended proximal water-carrying tubes;

FIG. 7F illustrates a two-piece ferrule construction that accommodates tips without extended water tubes such as the Sani-Tip®;

FIG. 7G illustrates an alternative two-piece ferrule construction that accommodates tips without extended water tubes such as the Sani-Tip®;

FIG. 7H illustrates a three-piece ferrule construction that accommodates tips without extended water tubes such as the Sani-Tip®;

FIG. 7I illustrates an alternative three-piece ferrule construction that accommodates tips without extended water tubes such as the Sani-Tip®;

FIGS. 8A-8G illustrate syringe systems to which the invention is applicable that feature stems protruding from the syringe body;

FIGS. 9A-9C illustrate syringe systems to which the invention is applicable that feature threaded connections between the syringe body and the tip which is removed;

FIGS. 10A-10F illustrate syringe systems to which the invention is applicable that feature stems protruding from the removed tip and into the syringe body;

FIGS. 11A-11D illustrate syringe systems to which the invention is applicable that feature tube projections from the removed tip and into the syringe body;

FIG. 12 is a cross section of a Castellini syringe body and a conversion kit enabling the syringe to accept disposable tips;

FIG. 13 is a cross section of a Cefla F3 LUZ syringe body and a conversion kit enabling the syringe to accept disposable tips;

FIG. 14 is a cross section of a Cefla F6 Anthos syringe body and a conversion kit enabling the syringe to accept disposable tips;

FIG. 15 is a cross section of a Chirana syringe body and a conversion kit enabling the syringe to accept disposable tips;

FIG. 16 is a cross section of a Faro SM03 syringe body and a conversion kit enabling the syringe to accept disposable tips;

FIG. 17 is a cross section of a Faro SYR syringe body and a conversion kit enabling the syringe to accept disposable tips;

FIG. 18 is a cross section of a Kayo 1056 syringe body and a conversion kit enabling the syringe to accept disposable tips;

FIG. 19 is a cross section of a Kayo 1056S syringe body and a conversion kit enabling the syringe to accept disposable tips;

FIG. 20 is a cross section of a Kayo 6F syringe body and a conversion kit enabling the syringe to accept disposable tips;

FIG. 21 is a cross section of a Kayo Systematica (with light) syringe body and a conversion kit enabling the syringe to accept disposable tips;

FIG. 22 is a cross section of a Kayo Systematica (without light) syringe body and a conversion kit enabling the syringe to accept disposable tips;

FIG. 23 is a cross section of a Kayo K4 syringe body and a conversion kit enabling the syringe to accept disposable tips;

FIG. 24 is a cross section of a Kayo Esthetica syringe body and a conversion kit enabling the syringe to accept disposable tips;

FIG. 25 is a cross section of a Sirona 4000 syringe body and a conversion kit enabling the syringe to accept disposable tips;

FIG. 26 is a cross section of a Sirona C8 Teneo syringe body and a conversion kit enabling the syringe to accept disposable tips;

FIG. 27 is a cross section of a Ritter Topjet syringe body and a conversion kit enabling the syringe to accept disposable tips;

FIG. 28 is a cross section of a Luzzani Mini Assistant syringe body and a conversion kit enabling the syringe to accept disposable tips;

FIG. 29 is a cross section of a Luzzani Mini Mate syringe body and a conversion kit enabling the syringe to accept disposable tips;

FIG. 30 is a cross section of a Luzzani Mini Light syringe body and a conversion kit enabling the syringe to accept disposable tips;

FIG. 31 is a cross section of a Luzzani Mini Brite syringe body and a conversion kit enabling the syringe to accept disposable tips;

FIG. 32 is a cross section of a Morita WS66 syringe body and a conversion kit enabling the syringe to accept disposable tips;

FIG. 33 is a cross section of a Morita WS97 syringe body and a conversion kit enabling the syringe to accept disposable tips;

FIG. 34 is a cross section of a Morita WS 12 syringe body and a conversion kit enabling the syringe to accept disposable tips; and

FIG. 35 is an exploded view of a Takara Belmont syringe body and a conversion kit enabling the syringe to accept disposable tips

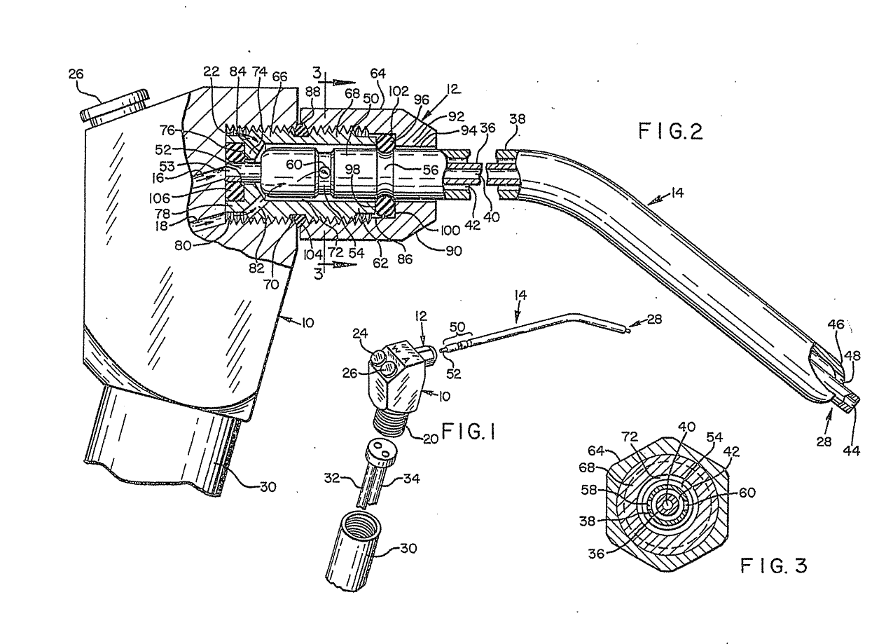

### DETAILED DESCRIPTION OF THE INVENTION

This invention improves upon existing air/water syringe instrumentation by providing conversion kits that enable replaceable, disposable tips to be used with various syringe assemblies, including European-style syringes. The invention is also applicable to disposable tips with disposable tips having extended proximal water tubes as well as tips with flush air/water passages on opposing flat proximal and distal ends. Nor is the invention limited in terms of the number of air-carrying channels surrounding the central water-carrying tube.

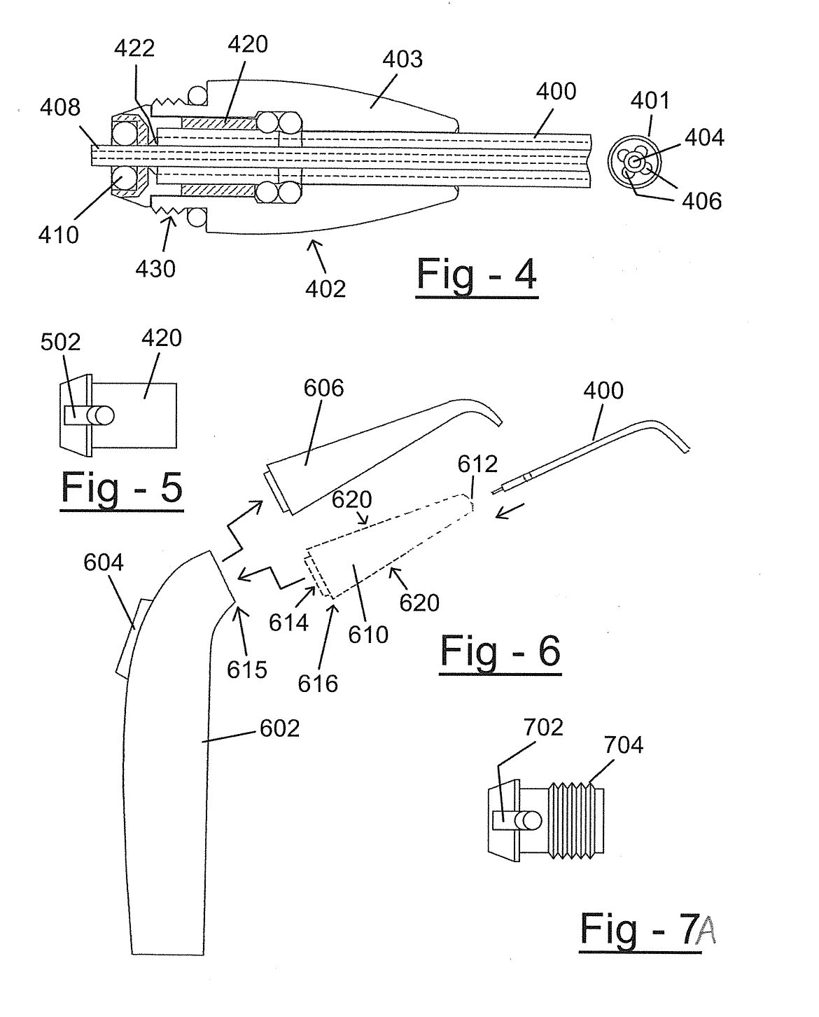

FIG. 6 is a simplified drawing showing a generic syringe body 602 with air/water control buttons 604. The figure also shows a generic autoclavable tip 606 which is removed from the body 602 and replaced with a retainer body 610 having a distal end 612 to receive disposable tip 400. The retainer is illustrated in broken-line form because it is a generic example with specific embodiments being described below with respect to detailed cross-sectional drawings. In all embodiments, however, air/water directing components internal to the retainer are installed through a proximal opening 614 in the retainer, such that the proximal portion 616 of the retainer can be flush against a corresponding portion 618 of the syringe body so that the outer surface 620 of the retainer can be smooth and seamless from the syringe to the distal end 612.

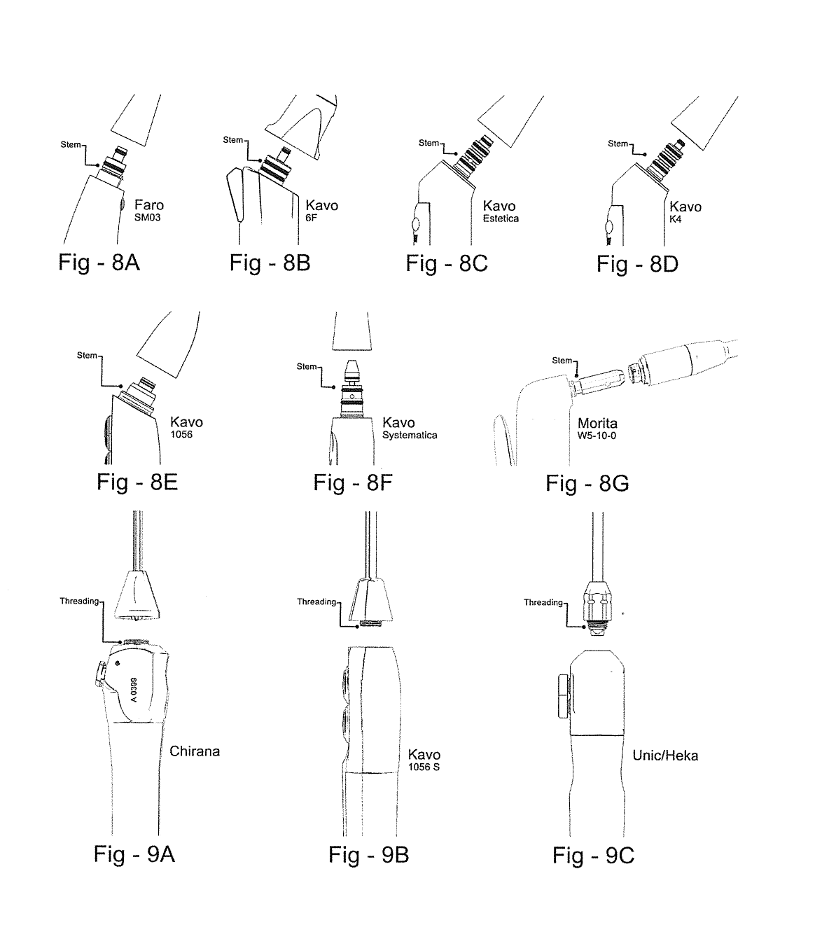

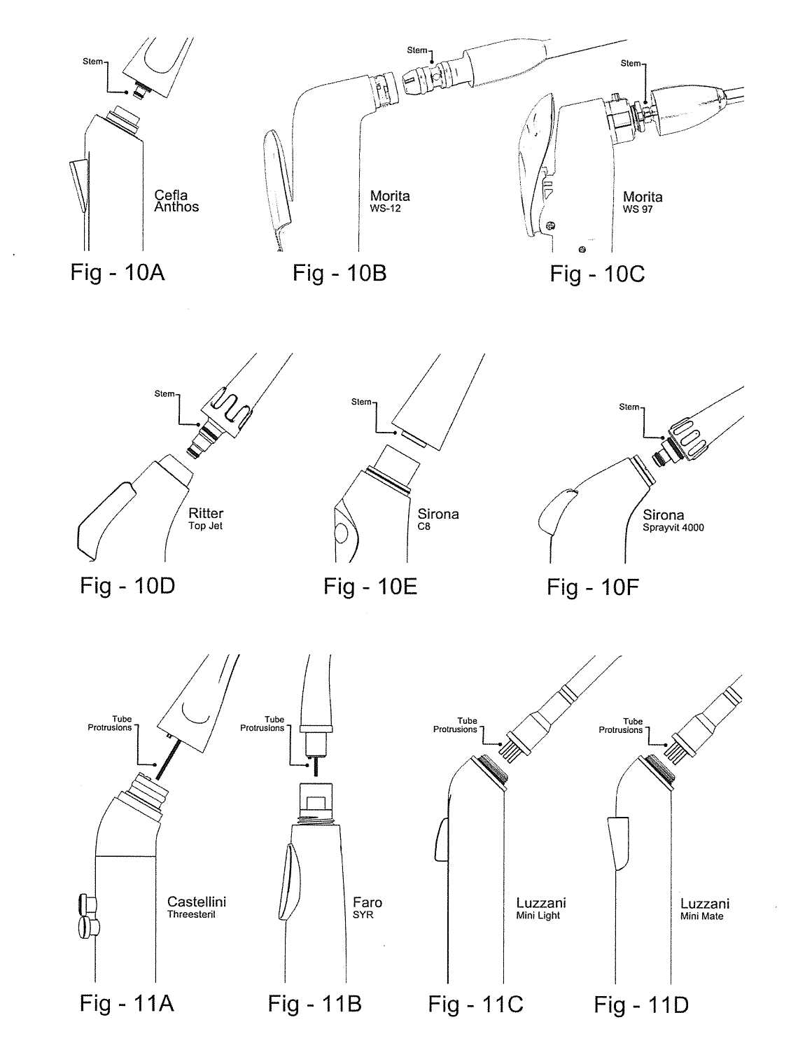

The components associated with the retainer body span a range of parts and complexity depending upon the type of syringe and the tip being replaced. That said, the invention accommodates all current styles and may be extended to yet-to-be developed designs with appropriate engineering modification. In particular, the invention includes conversion kits with retainers and components to accommodate syringe systems with stems that protrude from the syringe body, as exemplified in FIGS. 8A-8G; syringe systems that feature threaded connections between the syringe body and the tip without any prominent protrusions, as depicted in FIGS. 9A-9C; syringe systems with stems protruding from the removed tip, as shown in FIGS. 10A-10F; and syringe systems that feature tube projections from the removed tip, as shown in FIGS. 11A-11D.

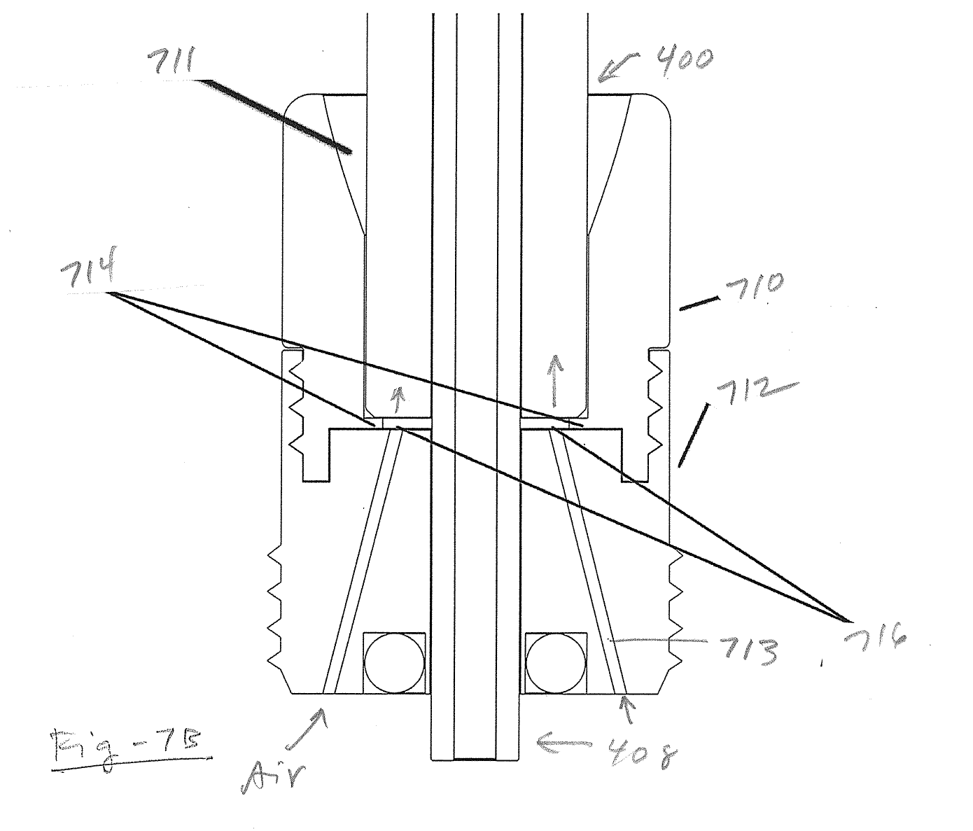

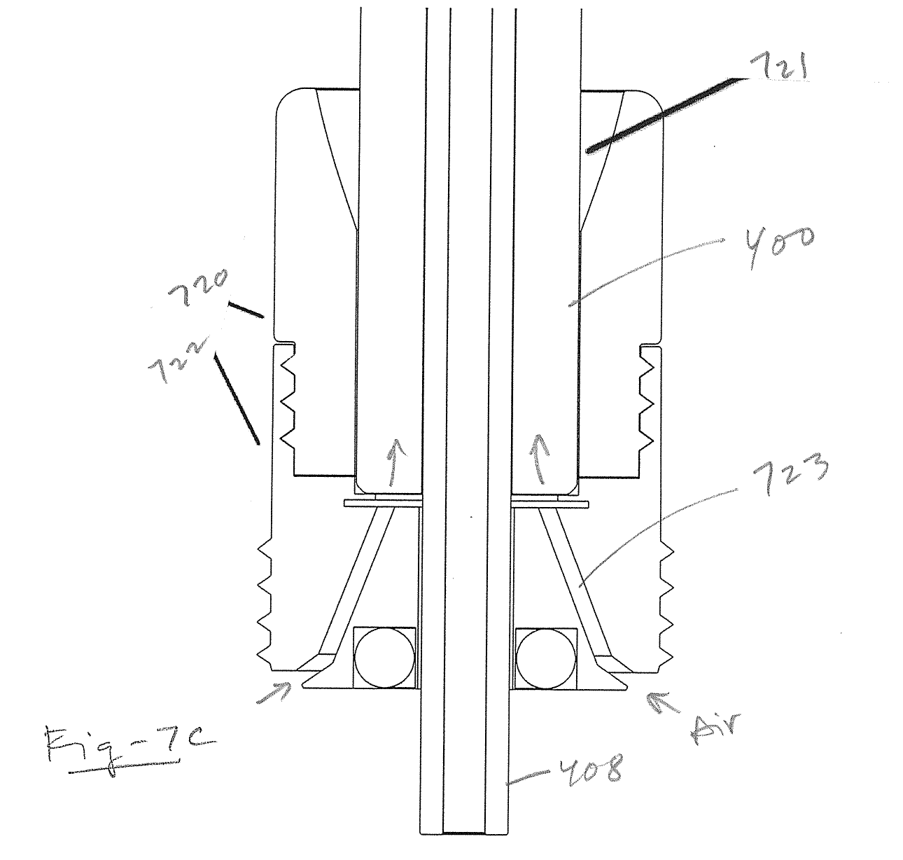

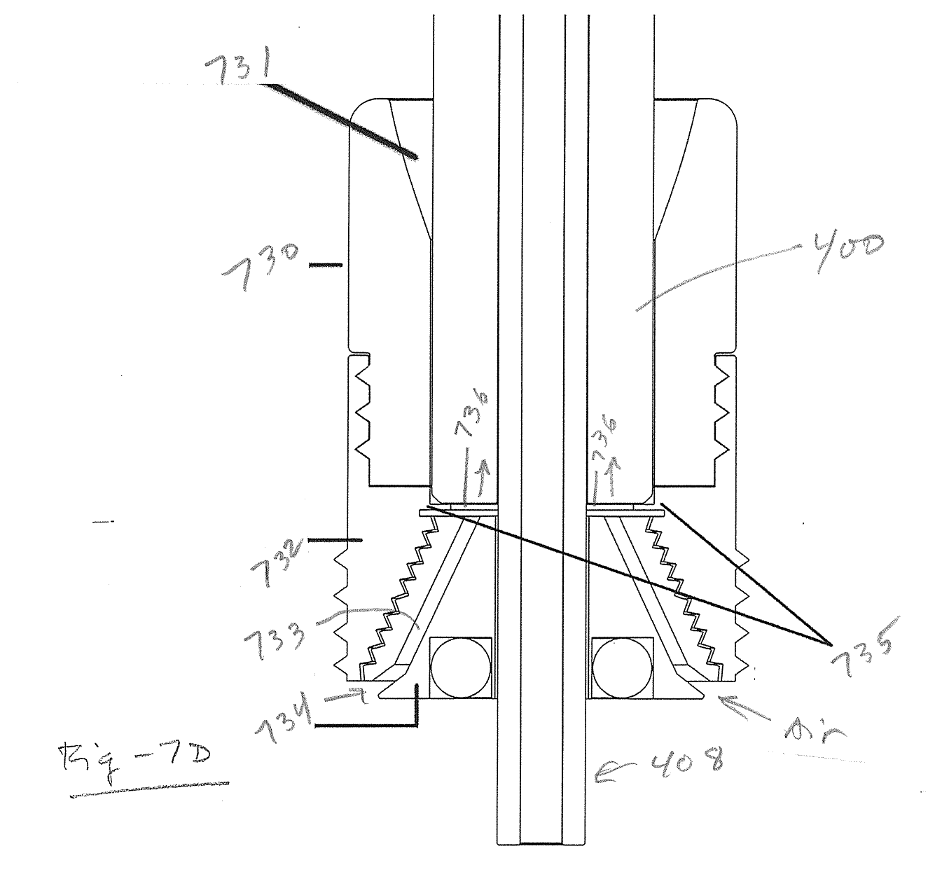

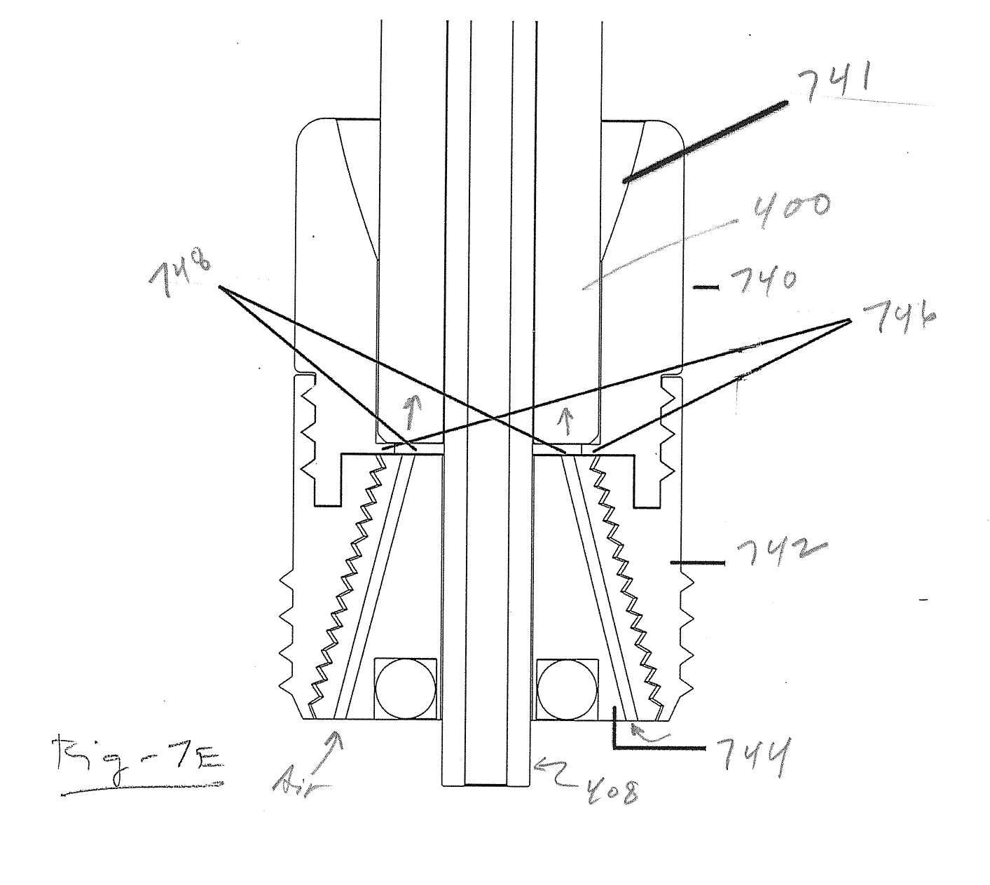

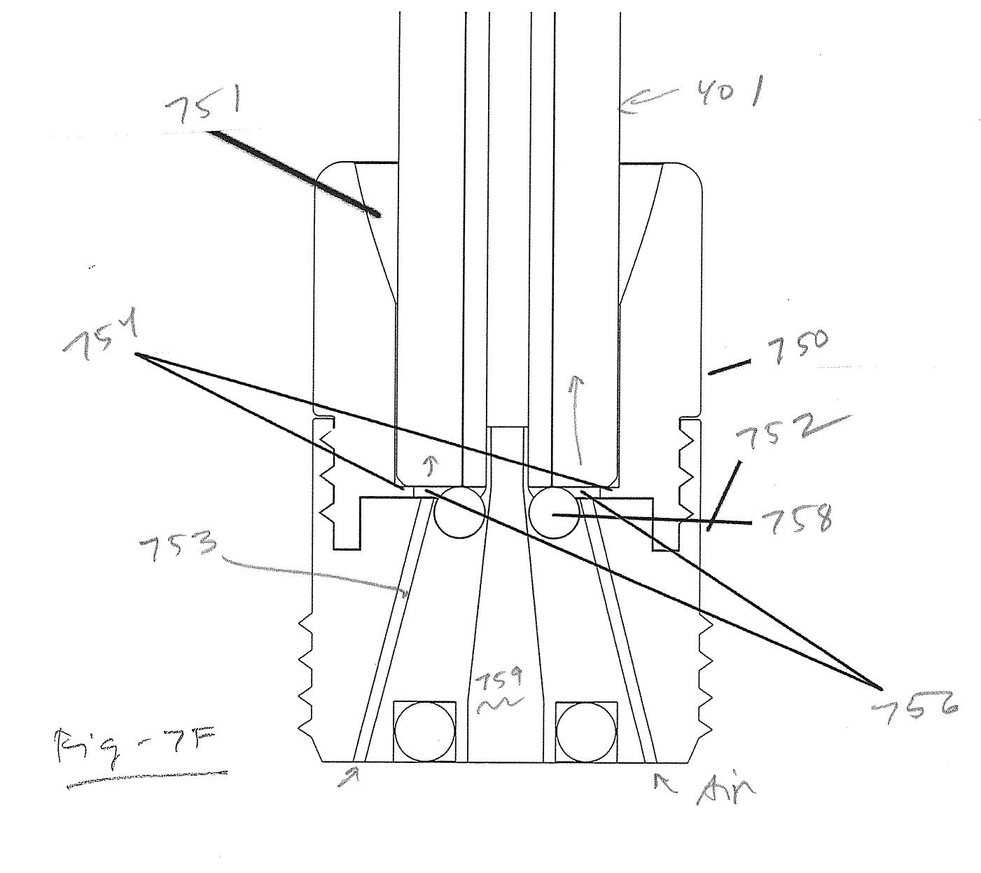

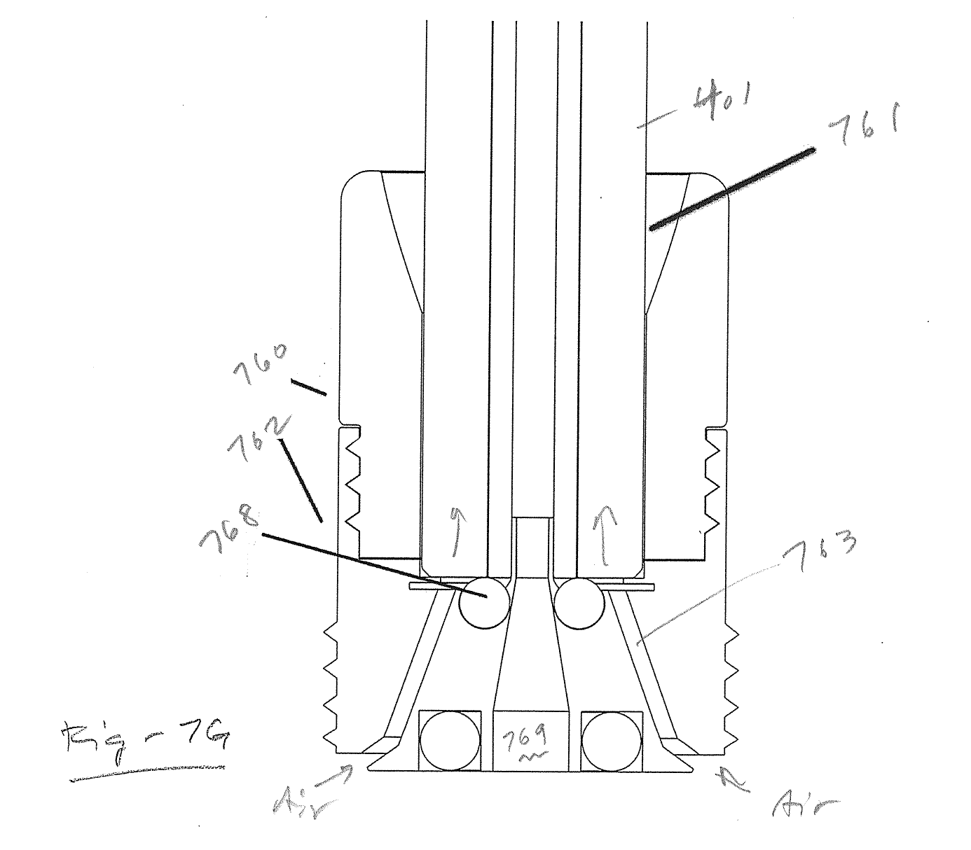

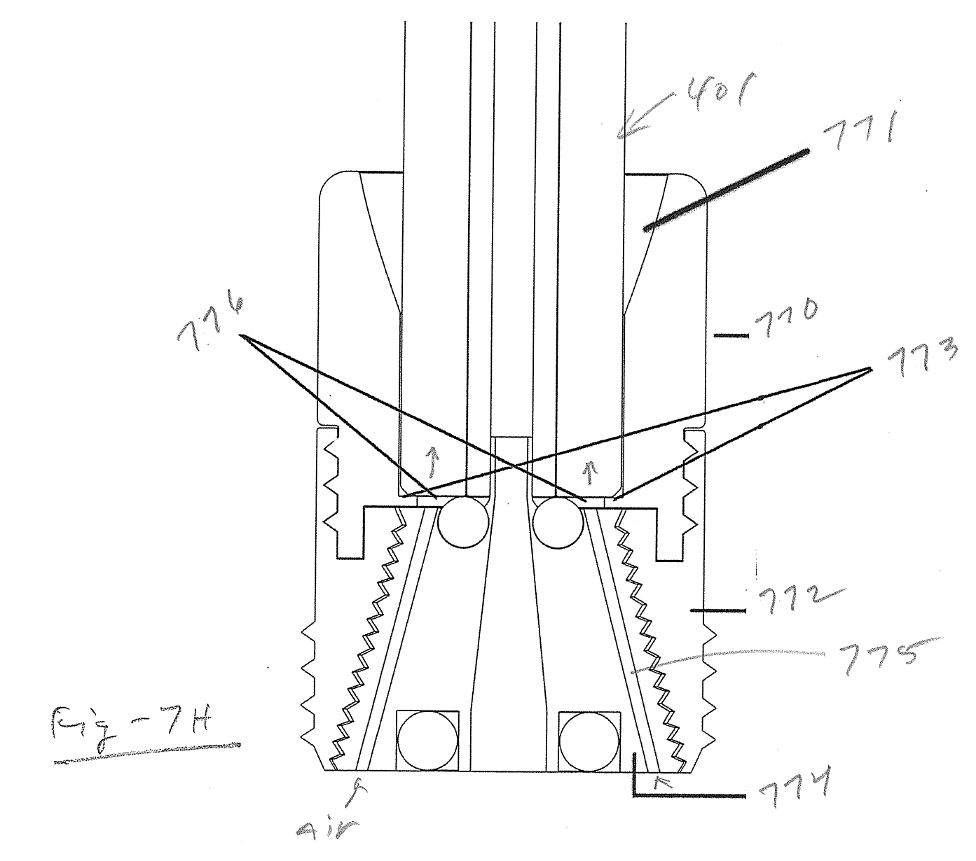

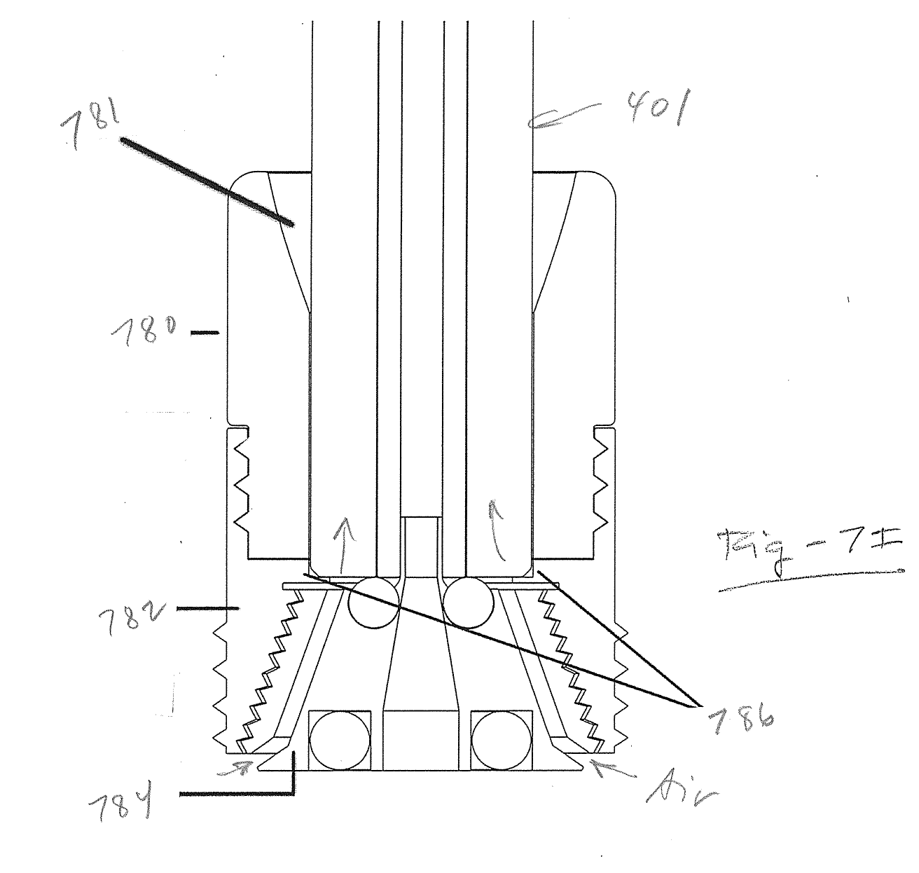

One component internal to the retainer body is a cup-shaped ferrule to receive the proximal end of the disposable tip once inserted into the distal end of the retainer. Such a ferrule, shown in FIG. 7A, may include a central opening through which water passes into the water-carrying tube of the disposable tip and one or more side cut-outs 702 through which air passes into the air-carrying channels of the disposable tip. The ferrule may further include a central opening to receive a water-carrying tube extending from the proximal end of the disposable tip. As with the other components internal to the retainer body, the ferrule is installed through the proximal opening in the retainer and preferably threaded at 704 to maintain its position.

While FIG. 7A illustrates a one-piece threaded ferrule applicable to the invention, two and three-piece designs are shown in FIGS. 7B-7I. FIGS. 7B-7E are applicable to disposable Crystal Tips with extended proximal water-carrying tubes, whereas FIGS. 7F-7I relate to ferrules that accommodate tips without extended water tubes such as the Sani-Tip®. FIG. 7B illustrates a two-piece ferrule comprising threaded portions 710, 712. Portion 710 preferably includes a tapered guide sleeve 711. Stops 714 create air gaps 716 enabling air to flow through diagonal channels 713 and into tip 400. The extended water-carrying tube is shown at 408. The use of stops to create air gaps, thereby preventing the proximal end of the tip from “bottoming out” is, by itself, unique in the industry and patentably distinct. So, too, is the use of double/multiple O-ring seals as evident in certain of the ferrule designs described herein and below.

FIG. 7C illustrates a two-piece ferrule comprising threaded portions 720, 722, with portion 720 preferably including a tapered guide sleeve 721. Cuts in portion 722 enable air to flow through channels 723 and into tip 400. FIG. 7D illustrates a three-piece ferrule comprising threaded portions 730, 732 and 734. Portion 730 preferably includes a tapered guide sleeve 731. Stops 735 create air gaps 736 enabling air to flow through diagonal channels 733 and into tip 400. FIG. 7E illustrates a three-piece ferrule comprising threaded portions 740, 742 and 744. Portion 740 preferably includes a tapered guide sleeve 741. The spacing between components 742, 744 create channels enabling air to flow into tip 400. Stops 746 prevent bottom ferrule tightening.

FIG. 7F illustrates a two-piece ferrule comprising threaded portions 750, 752. Portion 750 preferably includes a tapered guide sleeve 751. Stops 754 create air gaps 756 enabling air to flow through diagonal channels 753 and into disposable tip 401 of the Sani-Tip® type. Water-carrying channel 759 carries water in the center tube of the tip 401. Designation 758 refers to countersunk O-rings. FIG. 7G illustrates a two-piece ferrule comprising threaded portions 760, 762, with portion 760 preferably including a tapered guide sleeve 761. Cuts in portion 762 enable air to flow through channels 763 and into tip 401. Conduit 769 carries water into the center of the tip 401.

FIG. 7H illustrates a three-piece ferrule comprising threaded portions 770, 772 and 774. Portion 770 preferably includes a tapered guide sleeve 771. Stops 773 create air gaps 776 enabling air to flow through diagonal channels 775 and into tip 401. FIG. 7I illustrates a three-piece ferrule comprising threaded portions 780, 782 and 784. Portion 780 preferably includes a tapered guide sleeve 781. The spacing between components 782, 784 create channels enabling air to flow into tip 401. Stops 786 prevent bottom ferrule tightening.

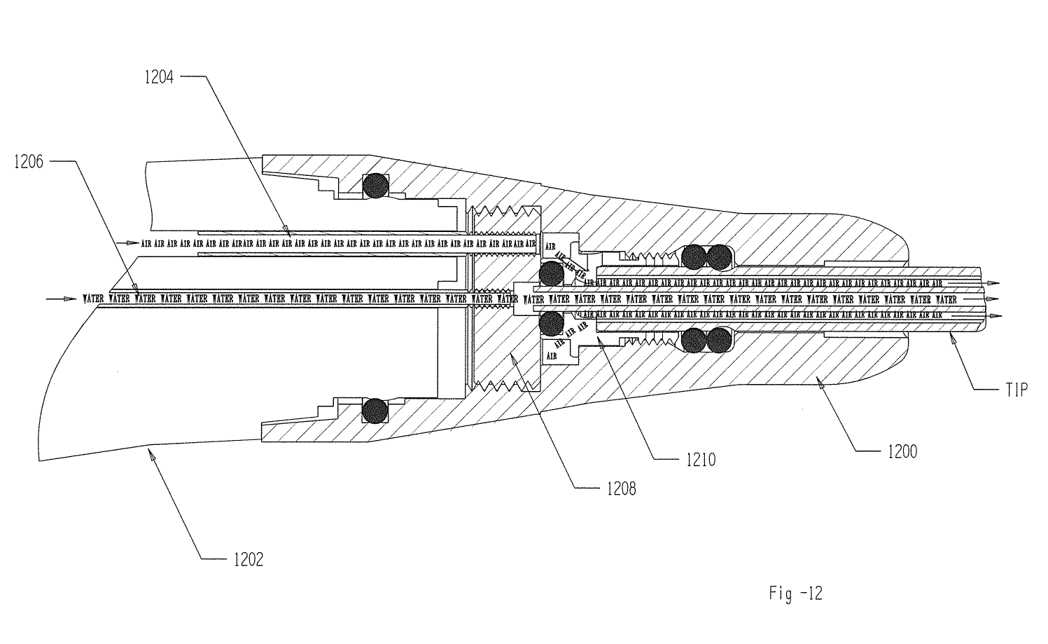

FIGS. 12 to 35 are detailed cross-sectional drawings that show conversion kits for particular syringe styles and, in some cases, modified ferrules depending upon the design requirements. In these drawings, the existing syringe body is shown without cross-hatching, whereas the cap and adapter subassemblies are cross-hatched. Air and water flows are also illustrated with text in each cross section. All conversion kits further include multiple O-rings, depicted as black circles. In terms of materials, the ferrules are preferably constructed of a brass alloy to achieve demanding tolerances, whereas the other hard components may be constructed of aluminum or hard plastic. Although certain of the conversion kits provide three or more components in addition to the O-rings, those of skill in the art will recognize that fewer pieces may be used through appropriate machining. For example, the ferrule and end cap may be formed of an integral unit by machining a single piece of brass or aluminum. While such fabrication may complicate the manufacturing process somewhat, the end result eliminates O-rings and simplifies assembly by the user.

While FIGS. 12 to 38 are well-understood and apparent to those of skill, comments will be made about incidental features and structures. FIG. 12 is a cross section of a Castellini syringe body and conversion kit. Note in this case that since the syringe body 1202 expects to receive elongated air/water tubes from the removed tip, they are provided at 1204, 1206 extending from internal component 1208. Threaded ferrule 1210 within retainer body 1200 receives the proximal end of the tip.

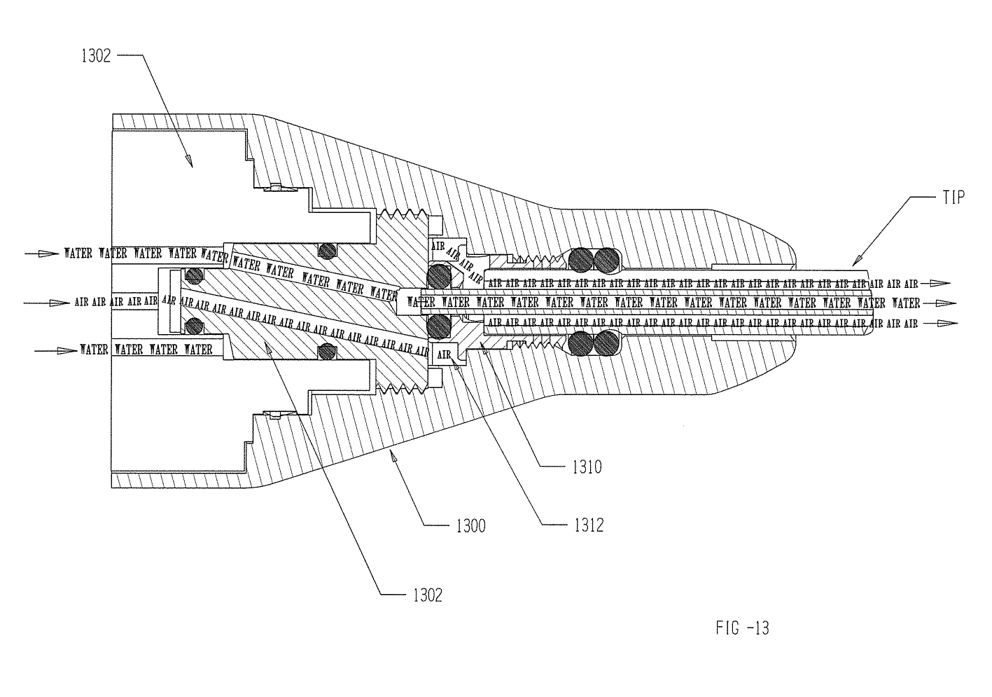

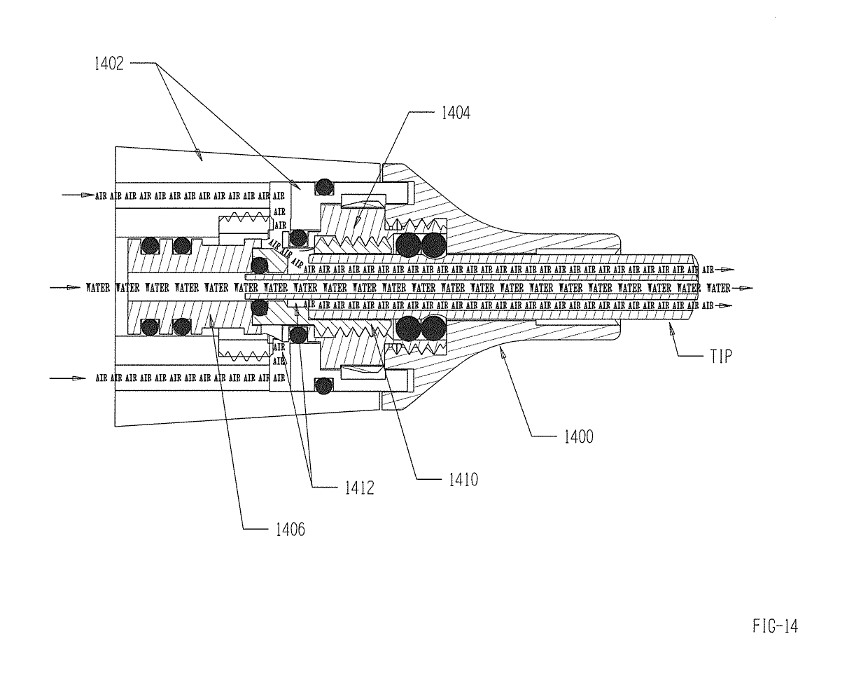

The Cefla Anthos F3 syringe body 1300 from Luzzani and conversion kit of FIG. 13 includes a stem component 1302 that guides air and water flows through angled channels to cavities around ferrule 1310. The configuration produces a radial air flow at 1312.

FIG. 14 is a cross section of a Cefla F6 Anthos syringe body and a conversion kit. The handpiece and screw-in insert are depicted at 1402. A separate component 1404 threads into the retainer body 1400 which, in turn, provides threads to receive ferrule 1410. Component 1406 provides a stem 1406 expected by the handpiece. As with the Cefla Anthos F3, a radial air flow is produced at 1412 prior to entry into the disposable tip.

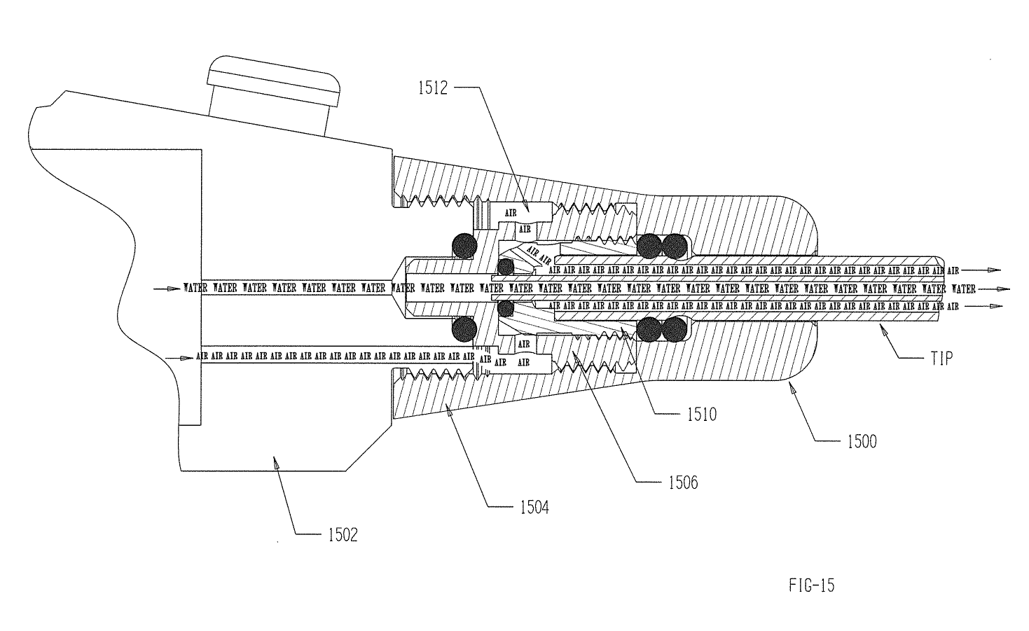

The Chirana syringe body and conversion kit of FIG. 15 provides an anticipated threaded connection at 1504 with no prominent protrusions as with the tip being replaced. The radial air flow at 1512 in this case is guided to ferrule 1510 through stem component 1506 which threads into retainer 1500. Ferrule 1510 in turn threads into the stem component 1506 as shown.

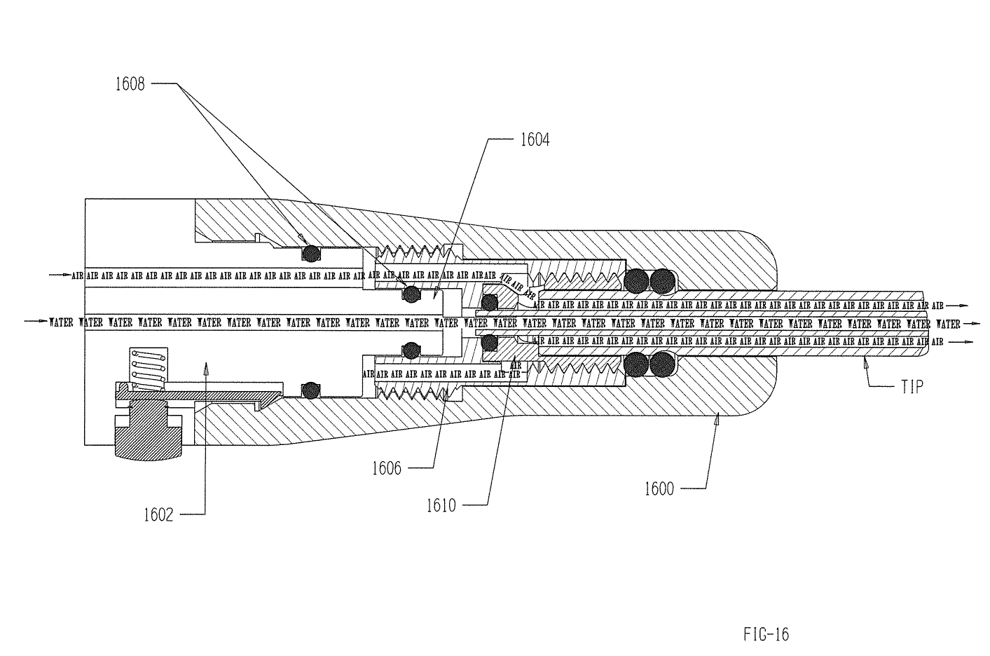

The Faro SM03 syringe of FIG. 16 qualifies as having a stem (1604) on the syringe body 1602. The OEM O-rings in this case are left on the stem 1604. Air is delivered through threaded insert 1606 to ferrule 1610. Ferrule 1610 threads into insert 1606 which threads into the retainer body 1600.

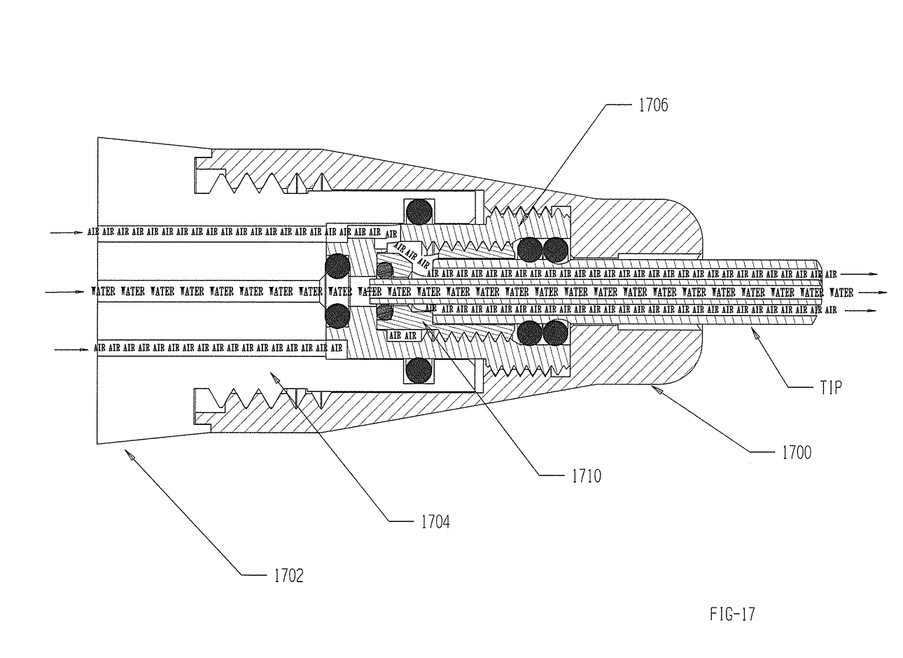

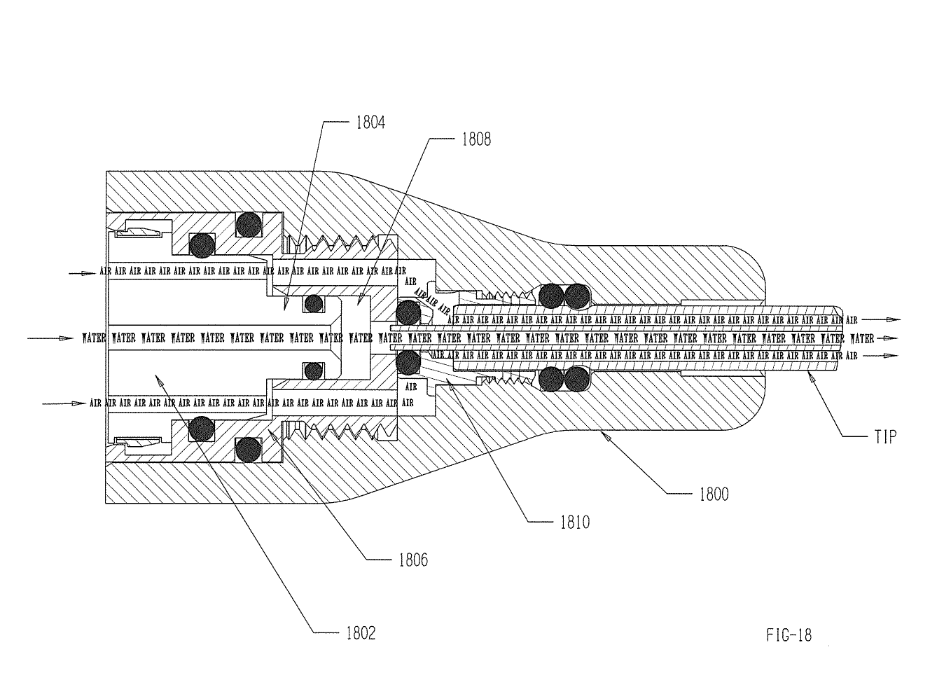

FIG. 17 is a cross section of a Faro SYR syringe body and a conversion kit. Retainer body 1700 makes a threaded connection to the syringe body 1702 at 1704. Ferrule 1710 screws into insert 1706 which threads into the retainer body 1700. The ferrule in this case includes three air slots to ensure compatibility with the design.

FIG. 18 is a cross section of a Kayo 1056 syringe body and a conversion kit. Ferrule 1810 is threaded into the retainer body 1800 as shown. A stem component 1706, threaded over the ferrule includes a proximal cavity 1808 to receive a stem 1804 on the hand piece 1802.

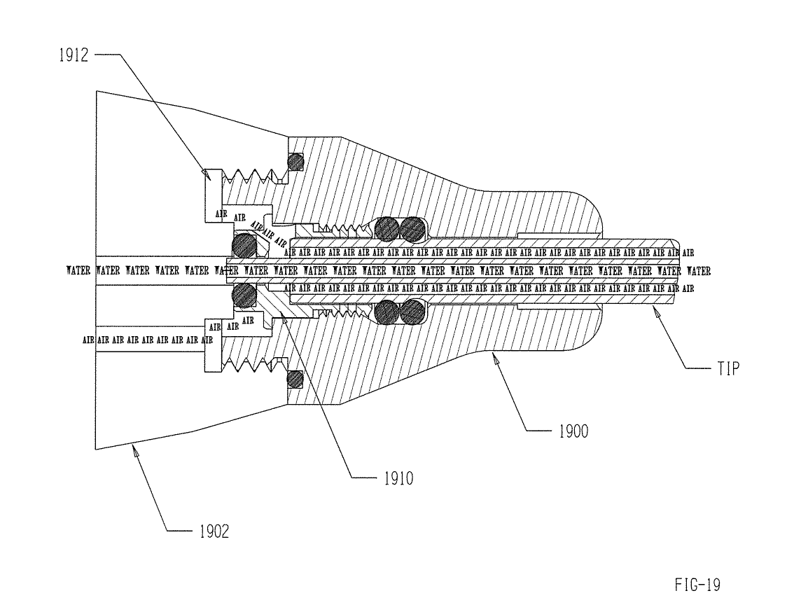

FIG. 19 is a cross section of a Kayo 1056S syringe body and a conversion kit which is quite simple, requiring only retainer body 1900 and ferrule 1910. The retainer is threaded onto the syringe handpiece 1902 such that a radial air flow is produced at 1912.

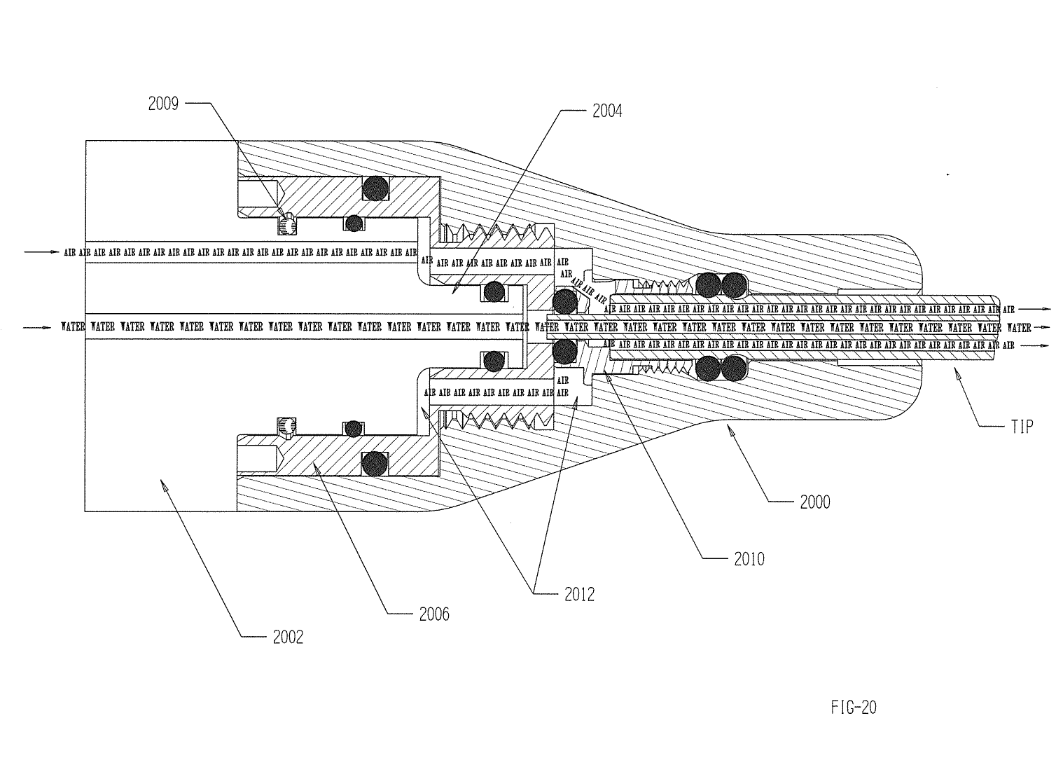

The Kayo 6F syringe body 2002 of FIG. 20 also includes a stem 2004 received by the conversion kit. A component 2006, threaded within retainer body 2000 receives the stem 2004. An OEM retaining ring 2008 is kept for use with the conversion kit. Ferrule 2010 is threaded into the retainer 200 prior to installation of component 2006 which also produces a radial air flow at 2012.

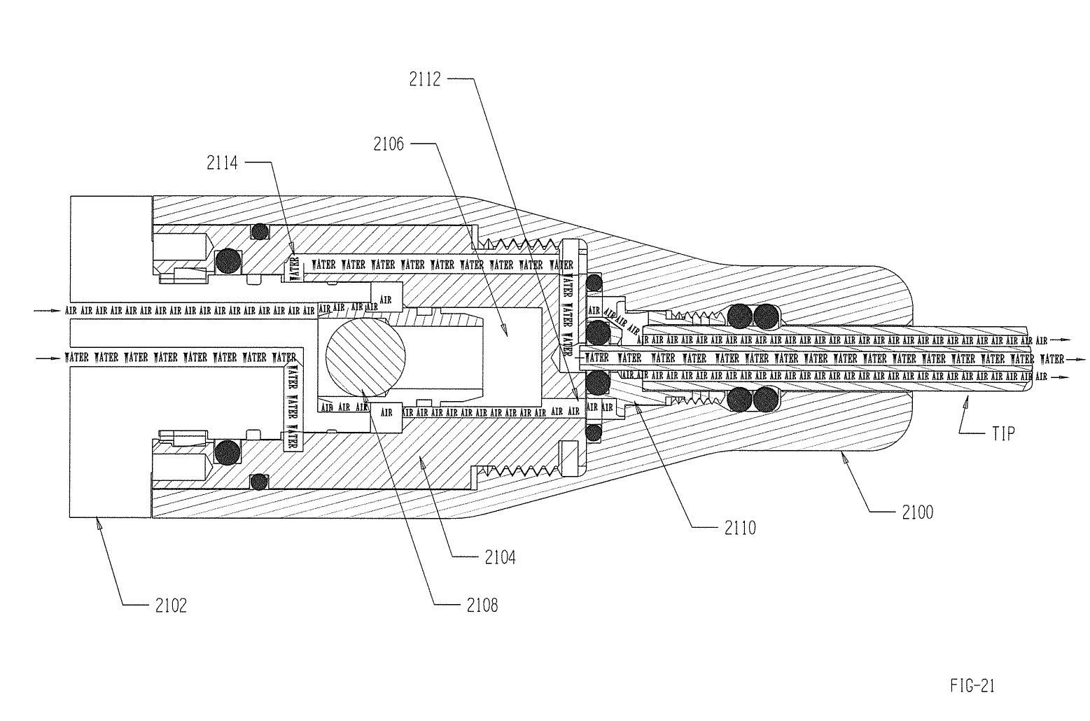

FIG. 21 is a cross section of a Kayo Systematica (with light) syringe system and the conversion kit for that unit. A component 2104, threaded into the retainer body 2100, includes a cavity 2106 to receive a stem on the syringe. The kit in this case includes a nylon plug 2108 to produce a radial air flow at 2112 and into ferrule 2110. In this case, a radial water flow is also produced at 2114.

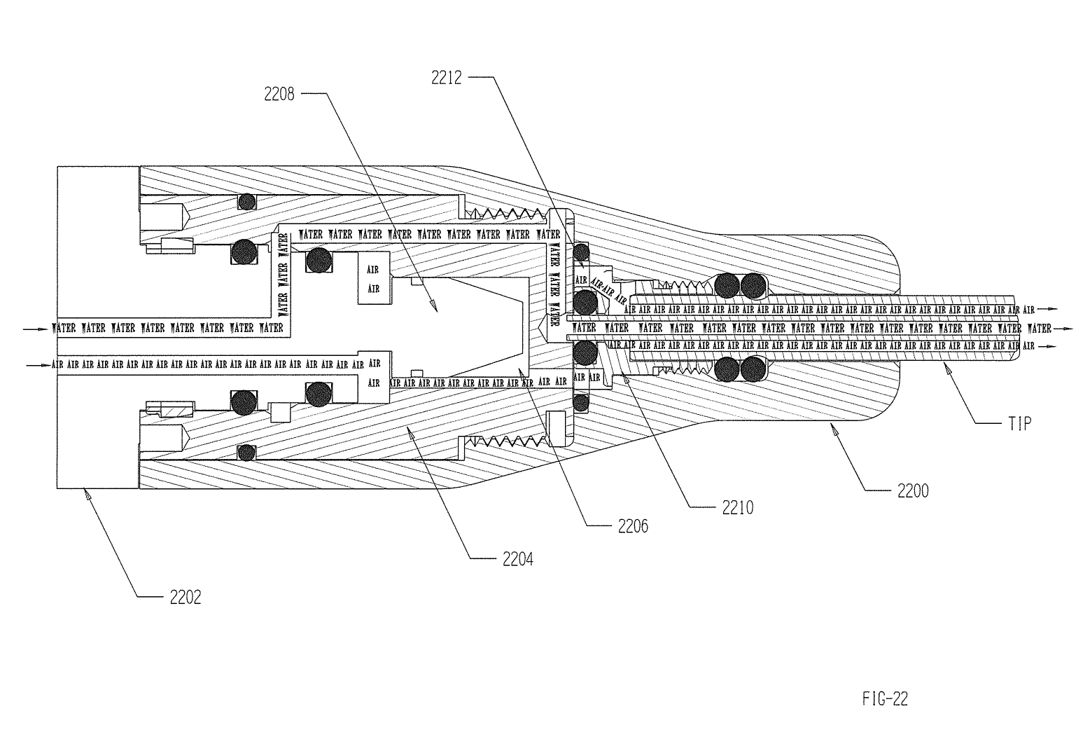

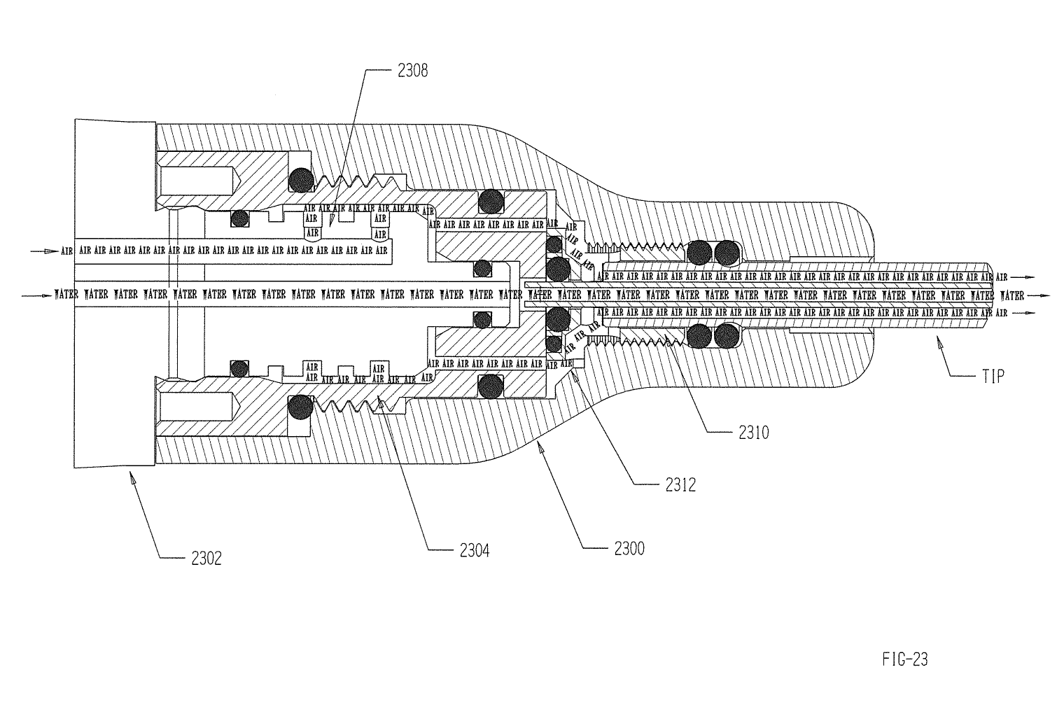

The conversion kit for the Kayo Systematica (without light) syringe of FIG. 22 is similar to the lighted version depicted in FIG. 21. Ferrule 2210 screws into the retainer body 2200, followed by component 2204 including a cavity 2206 to receive a stem 2208 protruding from the syringe system. A radial air flow is produced at 2212 but without a radial water flow.

FIG. 23 illustrates a conversion kit applicable to the Kayo K4 syringe. Note that in this and other embodiments of the invention, not all of the OEM O-rings provided on the stem 2308 of the syringe 2302 are replaced once removed to receive the conversion components. Ferrule 2310 screws into the retainer body 2300, followed by component 2304 including stepped cavities to receive the stepped stem protruding from the syringe system. A radial air flow is produced at 2312.

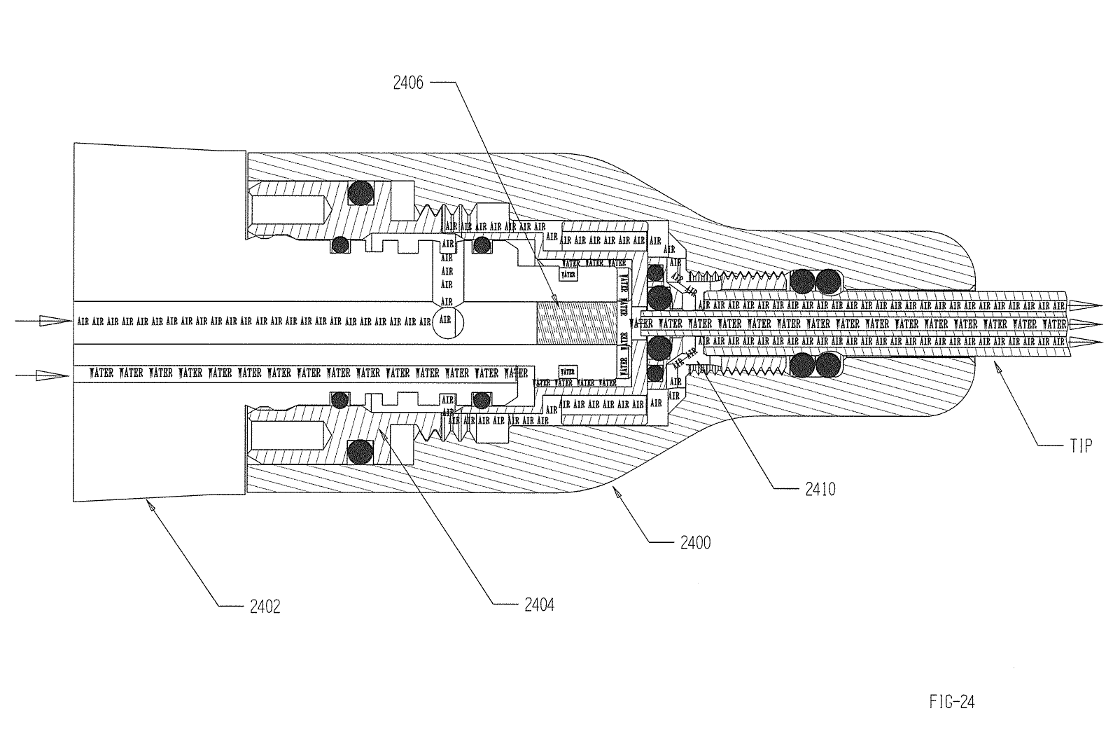

The Kayo Esthetica syringe body shown in FIG. 24 includes an elongated stem on the syringe body 2402, with air flowing out the side of the stem and into component 2404 which threads into retainer 2400. Component 2404 and ferrule 2410 cooperate to guide air and water to their respective destinations into the tip as shown. The system includes an OEM plug 2406 which is retained in the design.

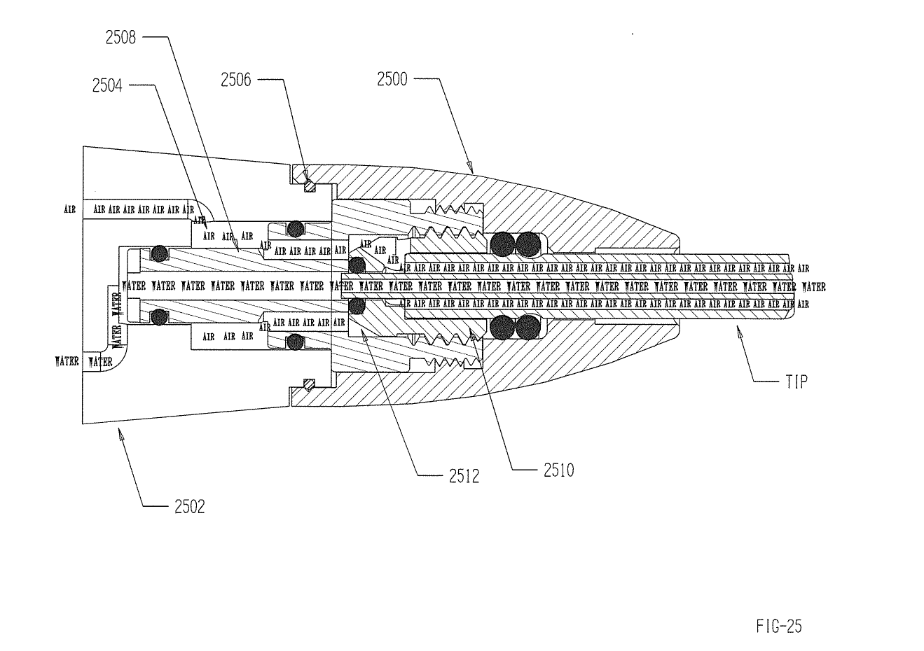

The Sirona 4000 system, shown in FIG. 25, includes a cavity 2504 to receive a stem component 2508 which is threaded into retainer body 2500. Ferrule 2510 threads into component 2508. An OEM spring clip 2506 is retained in the design. A radial air flow is produced at 2512.

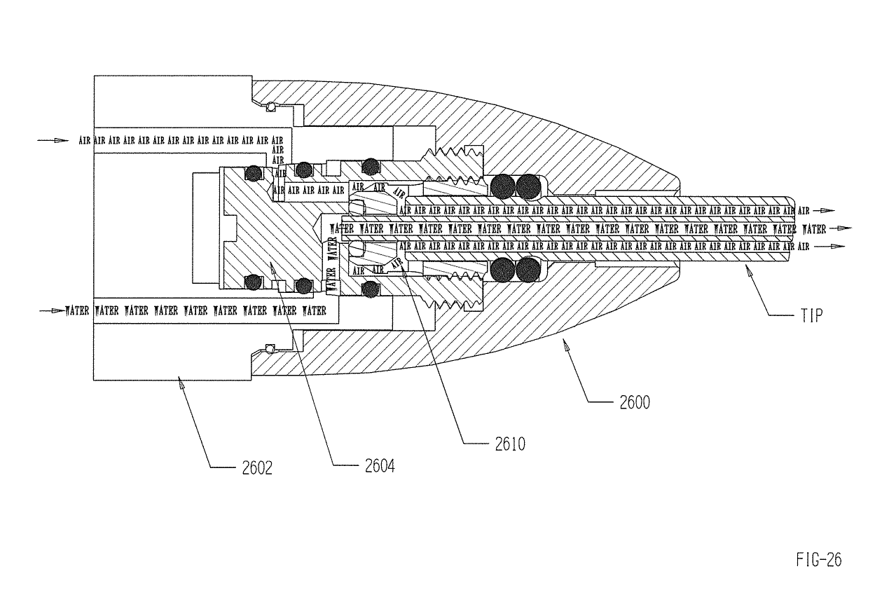

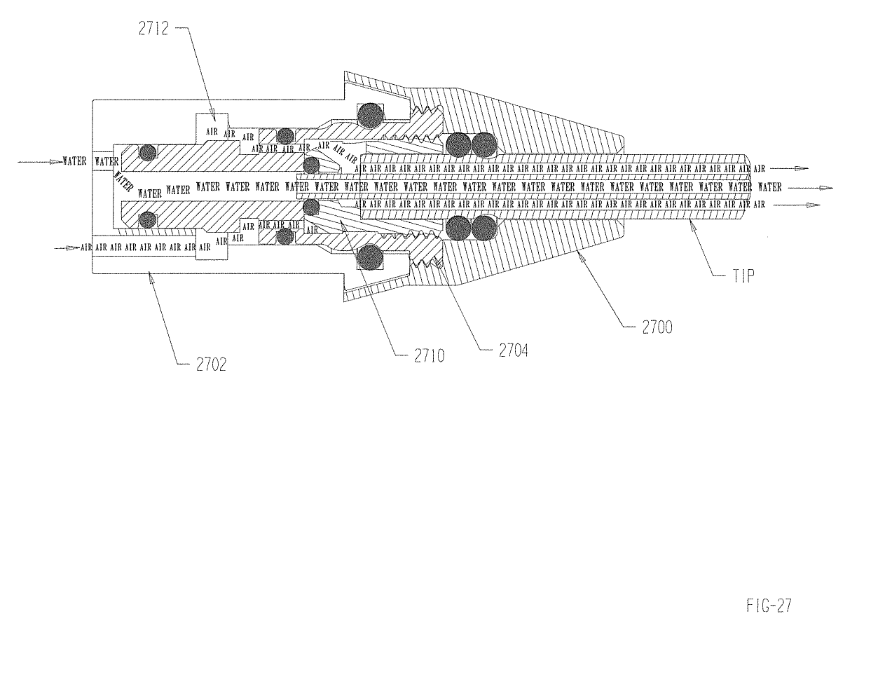

The Sirona C8 system of FIG. 26 is somewhat similar to the 4000 system of FIG. 25, with one exception being that both air and water are brought in through the sides of stem component 2604. In addition a slightly modified ferrule 2610 is used in this design. The ferrule 2610 is threaded into stem component 2604 which, in turn, is threaded into retainer body 2600.

FIG. 27 is a cross section of a Ritter Topjet syringe body 2702 and a conversion kit. Ferrule 2704 threads into a stem component 2704 which threads into retainer body 2700. A radial air flow is produced at 2712.

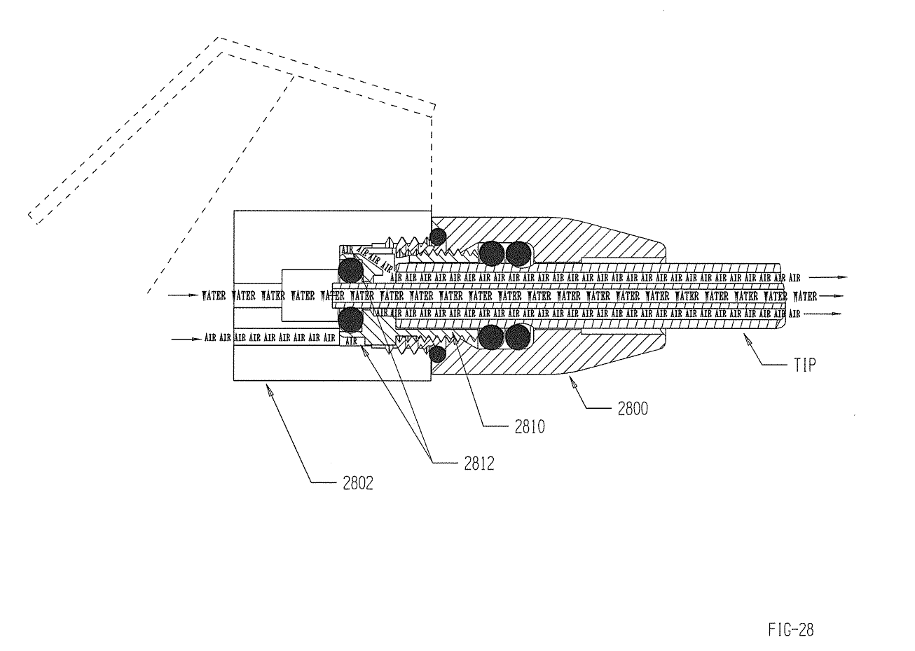

FIG. 28 relates to the Luzzani Mini Assistant syringe. The OEM receiver body less the handpiece is shown at 2802. The conversion kit in this case is also quite simple, requiring only ferrule 2810 threaded into retainer body 2800. The retainer body screws onto the syringe body 2802. A radial air flow is seen at 2812.

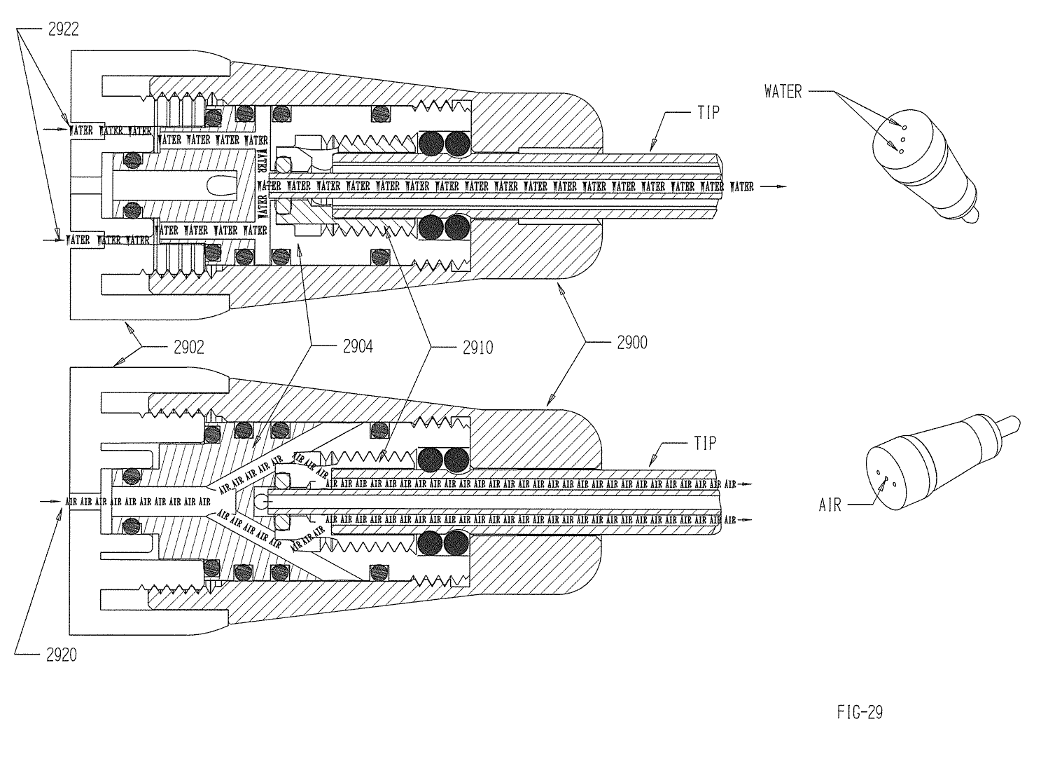

FIG. 29 is directed to the Luzzani Mini Mate system, with the OEM receiver indicated at 2902. Two views are shown to provide a complete picture. The upper drawing is rotated 90 degrees from the lower drawing. Air is brought in through a central passage 2920, while water is brought in through opposing side ports 2922. As shown in the upper drawing, water is channeled to a central region in insert 2904 which is threaded into retainer body 2900. As shown in the lower drawing, air is routed through diagonal channels and into ferrule 2910. The ferrule screws into the insert 2904 which is received by threads in the retainer body 2900.

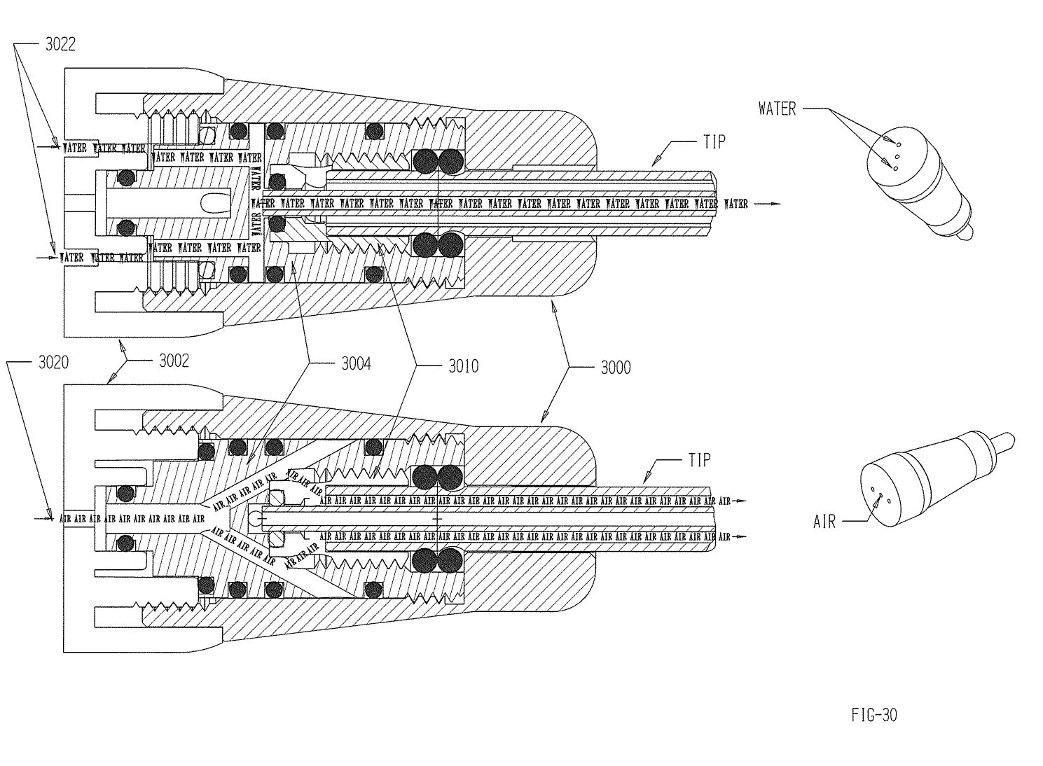

FIG. 30 is directed to the Luzzani Mini Light syringe body with associated conversion kit. The OEM receiver is indicated at 3002. Two views are again shown to provide a complete picture. The upper drawing is rotated 90 degrees from the lower drawing. Air is brought in through a central passage 3020, while water is brought in through opposing side ports 3022. As shown in the upper drawing, water is channeled to a central region in insert 3004 which is threaded into retainer body 3000. As shown in the lower drawing, air is routed through diagonal channels and into ferrule 3010. The ferrule screws into the insert 3004 which is received by threads in the retainer body 3000.

The Luzzani Mini Light is very similar to the Mini Mate except that the Mini Light includes a light source. In this case, at least a portion of the disposable tip may be constructed from a plastic such as Lucite which acts as a light pipe to conduct the illumination from the distal tip of the optical fiber to the distal end of the tip. As an alternative way to retain the illumination feature, the adapter subassembly may include along its length an optical fiber or solid light to conduct the illumination from the distal tip of the optical fiber to a light-emitting port disposed on the side of the adapter unit.

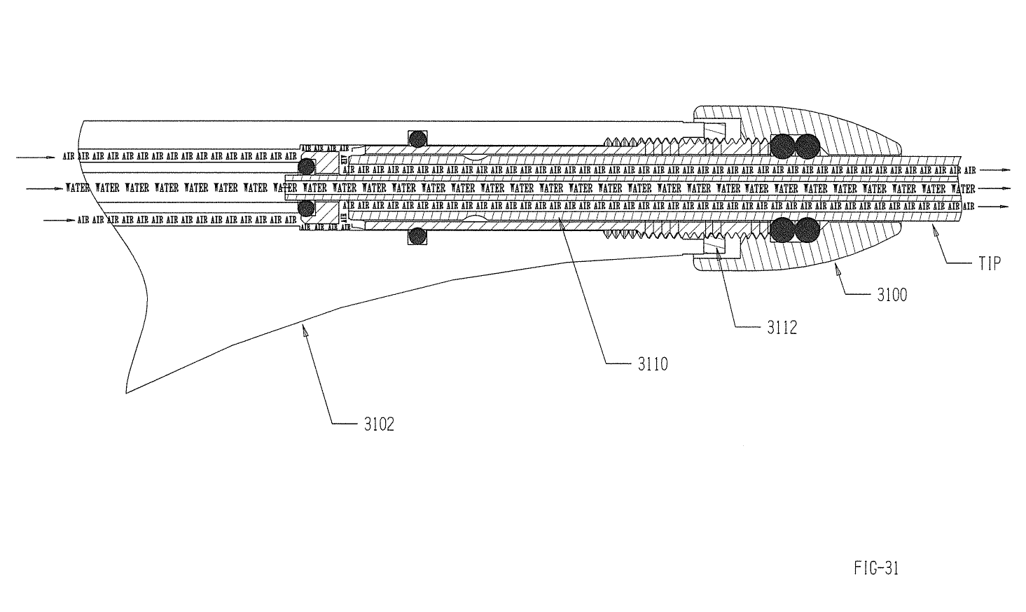

FIG. 31 is a cross section of a Luzzani Mini Brite syringe body and conversion kit which includes a component 3110 an elongated stem that extends deep into the syringe body 3102. The retainer body is shown at 3100, which mounts to the OEM receiver body with jam nut 3112. Note that the component 3110 amounts to an elongated ferrule in this case.

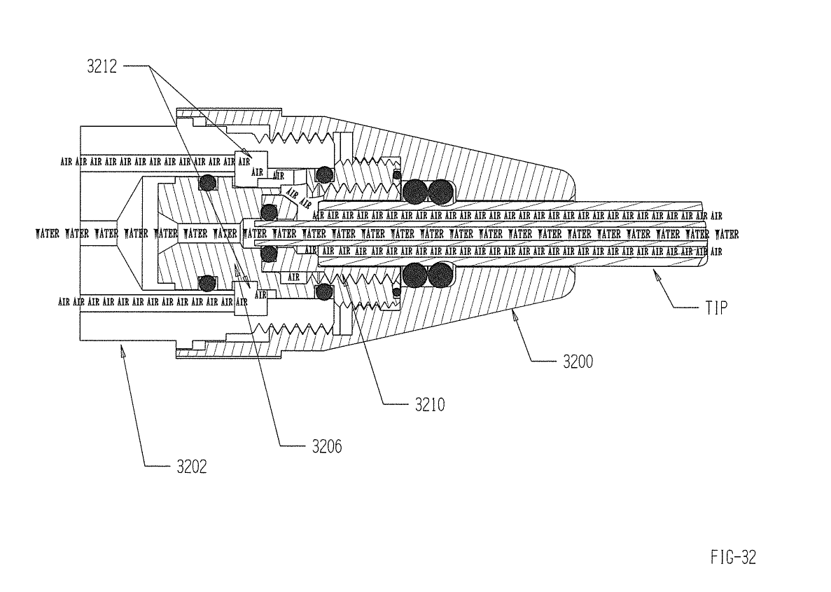

FIG. 32 depicts a conversion kit for the Morita WS66 syringe body 3202. Ferrule 3210 threads into a stem component 3206 which threads into retainer body 3200. A radial air flow is seen at 3212.

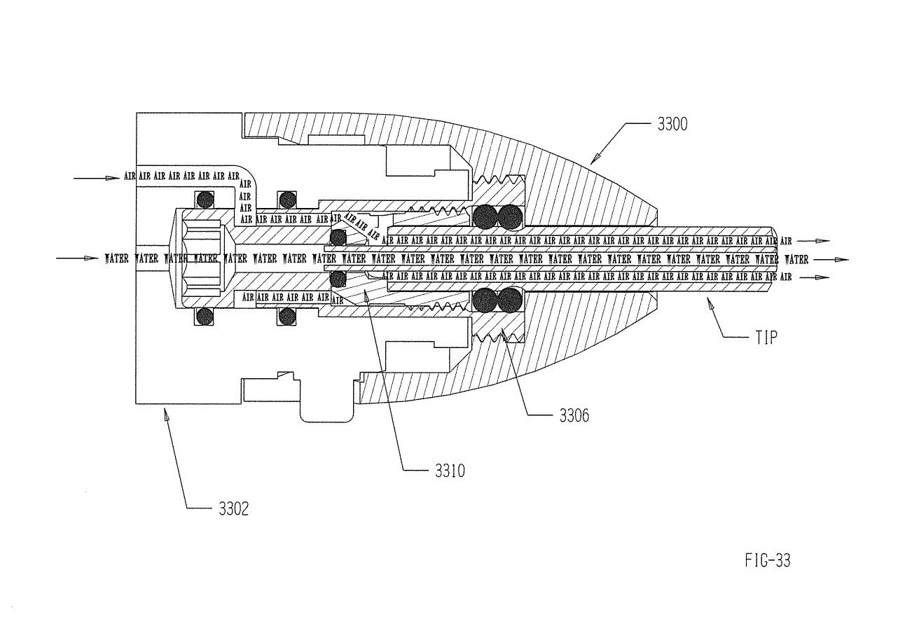

FIG. 33 depicts a conversion kit for the Morita WS97 syringe body 3302. A modified ferrule 3310 with three slots threads into a stem component 3306 which threads into retainer body 3300. Air comes in between a set of O-rings, through component 3306 and into ferrule 3310. Water comes up directly through the center of the assembly.

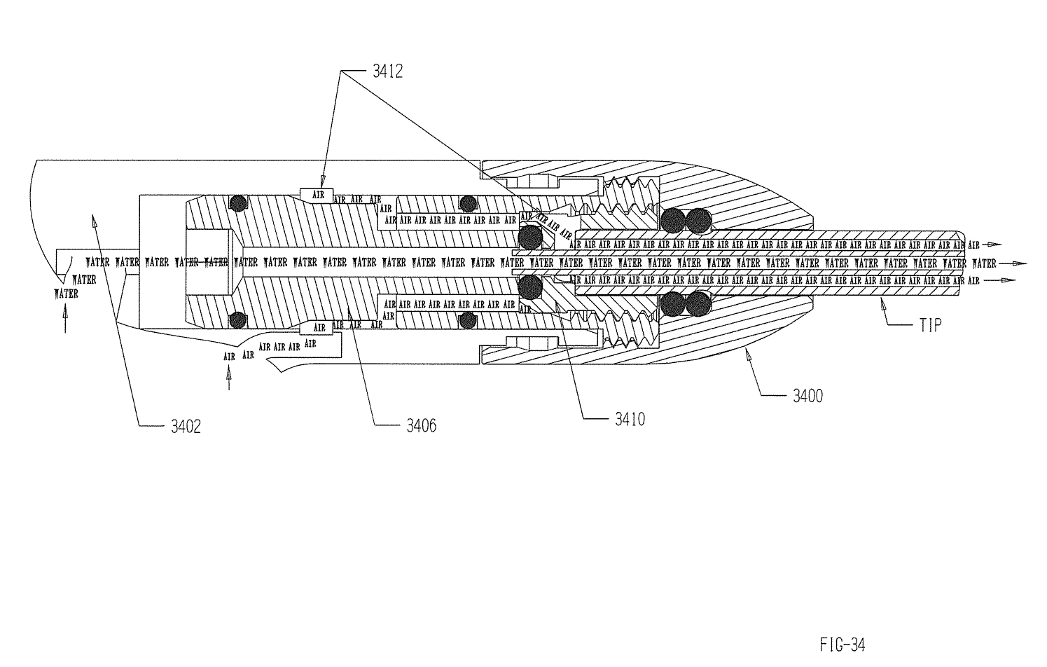

FIG. 34 depicts a conversion kit for the Morita WS97 syringe. The OEM arbor-less handpiece is shown at 3410. Ferrule 3410 threads into stem component 3406 which threads into retainer body 3400. Radial air flows 3412 are produced in two regions, as shown.

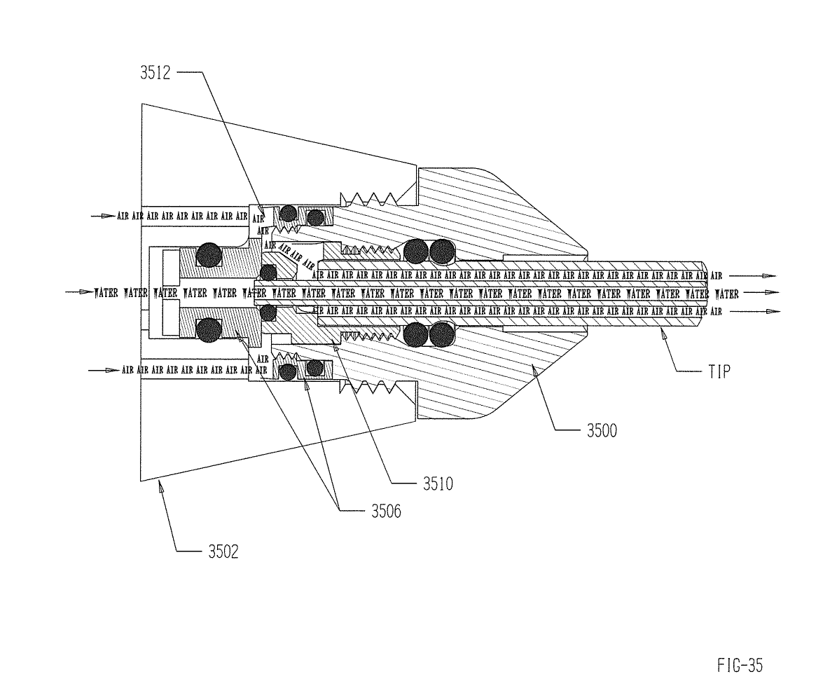

FIG. 35 illustrates a Takara Belmont syringe body 3502 and associated conversion kit. Ferrule 3510 threads into the retainer body 3500 which screws onto the OEM receiver. Component 3506 is trapped between the retainer and syringe bodies when the assembly is tightened. A radial air flow is produced at 3512.

I claim:

1. A conversion kit enabling an air/water syringe body to receive an elongated, disposable tip having proximal and distal ends and a central, water-carrying tube surrounded by air-carrying channels, the kit comprising:
a retainer body having an outer surface and a distal opening into which the proximal end of an elongated disposable tip is inserted;
the retainer further including a proximal opening into the retainer body, the proximal opening being larger than the distal opening;
one or more components with cut-outs, grooves or channels to direct air and water from the syringe body to the air-carrying channels and water-carrying tube of the disposable tip; and
wherein all of the components are installed within the retainer body through the proximal opening in the retainer body, such that the outer surface of the retainer is smooth and seamless.

2. The conversion kit of claim 1, wherein the retainer body or the components therein provide a proximal receptacle to receive a stem on the syringe body.

3. The conversion kit of claim 1, wherein at least one component within the retainer body includes a proximal stem insertable into the syringe body.

4. The conversion kit of claim 1, wherein at least one component within the retainer body includes one or more proximal air- or water-carrying tubes insertable into the syringe body.

5. The conversion kit of claim 1, wherein the retainer body includes internal threads for making a threaded connection to the syringe body.

6. The conversion kit of claim 1, wherein one of the components within the retainer body is a cup-shaped ferrule to receive the proximal end of the disposable tip once inserted into the distal opening of the retainer body.

7. The conversion kit of claim 1, wherein one of the components within the retainer body is a cup-shaped ferrule to receive the proximal end of the disposable tip, the ferrule including a central opening through which water passes into the water-carrying tube of the disposable tip and one or more side cut-outs through which air passes into the air-carrying channels of the disposable tip.

8. The conversion kit of claim 1, wherein one of the components within the retainer body is a cup-shaped ferrule with a central opening to receive a water-carrying tube extending from the proximal end of the disposable tip.

9. The conversion kit of claim 1, wherein the retainer body is autoclavable in the absence of the disposable tip.

10. A conversion kit enabling a disposable tip to connect to a dental syringe that supplies air and water through separate air and water ports, the tip having a central, water-carrying tube surrounded by a plurality of air-carrying channels, the tip having a proximal base surface with openings to the air-carrying passages, with the water tube extending outwardly from the base surface, the kit comprising:
a retainer body having an outer surface and a distal opening into which the proximal end of an elongated disposable tip is inserted;
the retainer further including a proximal opening into the retainer body, the proximal opening being larger than the distal opening;
one or more components with cut-outs, grooves or channels to direct air and water from the syringe body to the air-carrying channels and water-carrying tube of the disposable tip, wherein all of the components are installed within the retainer body through the proximal opening in the retainer body, such that the outer surface of the retainer is smooth and seamless.
the components within the retainer body providing an internal structure with a first path for coupling the water port of the syringe to the water-carrying tube of the tip, and a second path for coupling the air port of the syringe to the air-carrying channels of the disposable tip;
the components including a receptacle having a bottom portion cooperating with the proximal base surface of the tip once inserted into the cap subassembly, the receptacle further including an aperture through which the water-carrying tube of the tip extends;
wherein a cavity is established between the bottom portion of the receptacle and the base surface of the tip; and
wherein the receptacle includes one or more side apertures through which air from the syringe passes into the cavity and into the air-carrying passages of the tip.

11. The conversion kit of claim 10, wherein the receptacle is a separate component threaded into the retainer body through the proximal opening.

12. The conversion kit of claim 10, wherein the retainer body and internal components provide a proximal receptacle to receive a stem on the syringe body.

13. The conversion kit of claim 10, wherein one or more components internal to the retainer body provide a proximal stem insertable into the syringe body.

14. The conversion kit of claim 10, wherein one or more components internal to the retainer body provide one or more proximal air- or water-carrying tubes insertable into the syringe body.

15. The conversion kit of claim 10, wherein the retainer body includes a threaded connection to the syringe body.

16. The conversion kit of claim 10, wherein the retainer body and internal components are autoclavable in the absence of the disposable tip.

17. A method enabling a dental syringe having an existing tip to instead receive a disposable tip having a central, water-carrying tube surrounded by a plurality of air-carrying channels, comprises the steps of:
removing the existing tip from the syringe;
coupling a retainer body to the syringe, the body having proximal end adapted for connection to the syringe in place of the existing tip, and a distal end with an opening to receive the proximal end of a disposable tip, the retainer body including one or more internal components providing a first path for coupling the water port of the syringe to the water-carrying tube of the tip and a second path for coupling the air port of the syringe to the air-carrying channels of the tip; and
inserting the proximal end of the tip into the distal end of the retainer body such that water is able to flow from the syringe through the water-carrying tube of the disposable tip, and air from the syringe is able to flow from the syringe through the air-carrying channels of the disposable tip.

18. The method of claim 17, including the step of providing a retainer body with internal components providing a proximal receptacle to receive a stem on the syringe.

19. The method of claim 17, including the step of providing a retainer body with internal components providing a proximal stem insertable into the syringe.

20. The method of claim 17, including the step of providing a retainer body with internal components providing one or more proximal air- or water-carrying tubes insertable into the syringe.

21. The method of claim 17, including the step of screwing the retainer body onto the syringe body.
